(19) United States
(12) Patent Application Publication
(10) Pub. No.: US 2008/0209984 A1
(43) Pub. Date: Sep. 4, 2008

(54) SUPPORTING MEMBER FOR GAS SENSOR

(75) Inventor: Kouhei YAMADA, Oobu-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/953,331

(22) Filed: Dec. 10, 2007

(30) Foreign Application Priority Data
Dec. 11, 2006 (JP) 2006-333224

(51) Int. Cl. G01N 7/00

(52) U.S. Cl. 73/31.05

(57) ABSTRACT

A device for fixedly supporting a sensor so that the sensor is exposed to a gas to be measured flowing through a passage is provided. The sensor comprises a gas sensing element that detects a physical characteristic of the gas, and a cover that surrounds the sensing element and has a gas inlet hole through which the gas is introduced inside the gas cover. The supporting device is arranged to face the gas inlet hole outside the cover so as to have a gap left between the supporting device and the gas cover.

### CROSS REFERENCE TO RELATED APPLICATION

The present application relates to and incorporated by reference Japanese Patent Application No. 2006-333224 filed on Dec. 11, 2006.

### BACKGROUND OF THE INVENTION

1. The Field of the Invention

The present invention relates to a supporting member that supports a sensor having a sensing element which detects at least one of physical characteristics of a measurement gas, the sensor being arranged to be exposed to a measurement gas. For example, the present invention relates to a supporting member for a gas sensor which measures the concentration of a specific component contained in the exhaust emissions of an internal combustion engine of an automotive vehicle flowing through a gas flowing path, such as the exhaust passage of the exhaust system of an internal combustion engine.

2. Description of the Related Art

Various types of gas sensors are installed in the exhaust pipe of an automotive vehicle in order to measure the concentration of a specific gas component contained in the exhaust emissions of the internal combustion engine. This specific gas, for example, includes nitrogen oxide (NO, NO₂), sulfur dioxide (SO₂), oxygen (O₂) and water (H₂O) in atmospheric air and engine exhaust gases.

For example, a nitrogen oxide (NOx) sensor that measures the concentration of nitrogen oxide is installed in an automotive vehicle to implement feedback control of the internal combustion engine of the automotive vehicle to reduce emission of nitrogen oxides (NOx) therefrom. The nitrogen oxide sensor is usually located at a point in the engine exhaust passage downstream of a catalytic converter in order to determine whether or not the catalytic converter has significantly deteriorated.

Further, there has been known a technique that the concentration of oxygen in the exhaust emission of the internal combustion engine is measured to control an air fuel ratio (i.e., ratio of air to fuel) of a mixture supplied to the internal combustion engine under a feedback control, thereby purifying the engine exhaust gas, i.e., reducing pollution and improving fuel consumption.

There are known installation structures of one of the gas sensors mentioned above to an exhaust pipe of the internal combustion engine to detect the concentration of the specific gas component contained in a measurement gas, such as the exhaust emission.

One of the known installation structures disclosed in Japanese Laid-Open Patent Publication No. 2001-228112 comprises a gas sensor and a gas flowing path. The gas sensor has a sensing element, a housing, and a gas cover. The sensing element has a function of detecting a specific gas component contained in the measurement gas such as nitrogen oxide (NOx), oxygen (O₂) and the like. The housing contains the sensing element therein and is supported in the measurement gas flowing path such that the gas sensor is exposed to a flow of the measurement gas. For example, the measurement gas is the exhaust emission of an internal combustion engine, and the gas flowing path is the exhaust pipe of the exhaust system of an internal combustion engine. The exhaust pipe is shaped locally like a boss cylinder which has a central axis along a longitudinal direction thereof and a substantially circular shaped cross section. In this case, the sensor having a longitudinal center line is installed in the exhaust pipe such that the longitudinal center line is substantially perpendicular to a peripheral surface of the exhaust pipe. The sensing element is retained within the housing and has a given length extending in the longitudinal center line of the gas sensor. The housing possesses a hollow cylindrical shape. The gas sensor has a base side end and a tip side end opposite to the base side end along the longitudinal center line thereof. The tip side end is defined as the end with the gas cover is installed. For example, a gas cover shaped like a cap. Thus, the tip side end of the gas sensor is located in the gas flow path and is exposed to the flow of the measurement gas. Preferably the gas cover is made up of an outer cover and an inner cover, typically both the inner cover and the outer cover being shaped like a cap. The diameter of the cap of the outer cover is larger than that of the inner cover. However, it is not always true that the height of the cap of the outer cover is taller than that of the inner cover. The inner cover defines a gas chamber therein. In the gas chamber, the sensing element detects the measurement gas. Both the inner cover and the outer cover have corresponding gas inlet holes through which the measurement gas is admitted into a clearance between the inner cover and the outer cover, and then into the gas chamber in the inner cover. The inner cover is surrounded by the outer cover. The cover is joined to the tip side end of the housing. The position at which the gas inlet hole of the outer cover is formed is different from that at which the gas inlet hole of the inner cover is formed along the longitudinal center line of the gas sensor. Further the rotation angle of the gas inlet hole of the outer cover in the plane perpendicular to the longitudinal center axis of the gas sensor is different from that of the gas inlet hole of the inner cover. The rotation angle is measured, for example, with respect to the central axis of the exhaust pipe. Hence, the clearance defines a gap path which extends substantially in the longitudinal direction of the gas sensor and establishes a gas flow directed from the gas inlet hole of the outer cover into the gas chamber through the gas inlet hole of the inner cover.

In the installation structures disclosed in Japanese Laid-Open Patent Publication No. 2001-228112, the gas inlet hole of the outer cover nearest to the tip end of the gas sensor is located within a predetermined distance from the central axis of the exhaust pipe of the exhaust system of an internal combustion engine, wherein the predetermined distance is smaller than one-third of a diameter of the cross section of the exhaust pipe. In this case, the outer cover of the gas sensor may have a gas inlet hole or a plurality of gas inlet holes, and the inner cover also has a gas inlet hole or a plurality of gas inlet holes. Further, the position of the gas inlet hole of the outer cover is not limited to that disclosed above, and it is possible that the position of the gas inlet hole of the outer cover is located outside of a circle whose diameter is smaller than one-third of a diameter of the cross section of the exhaust pipe. For example, the gas inlet hole of the outer cover can be arranged in the vicinity of the base side end of the outer cover, that is, may not be located in the vicinity of the central axis of the exhaust pipe, but in the vicinity of a peripheral interior surface of the exhaust pipe.

The cover is intended to obtain a uniform flow of the measurement gas around the sensing element and to avoid any adhesion of condensed water (so-called “water splash”) to the gas sensing element caused when the internal combustion engine is started.

Further, the gas sensor usually has a heater to heat the gas sensor up to the activation temperature range. If adhesion of condensed water to the heater or the sensing element occurs, the heater or the sensing element will be damaged due to rapid cooling thermal shock. For example, an oxygen sensor that measures the concentration of oxygen contained in a measurement gas requires keeping the gas sensor within an activation range of 400 degrees Celsius or more. If condensed water adheres to the heater or the sensing element, the heater or the sensing element will be subjected to thermal stress generated and may break due to the rapid cooling thermal shock.

In a cold environment, condensed water can be present at the interior peripheral surface of the exhaust pipe of the exhaust system of the internal combustion engine due to condensation of water included in the exhaust emissions of the internal combustion engine and atmosphere.

If the internal combustion engine is started in the presence of the condensed water on the interior peripheral surface of the exhaust pipe, especially when temperature of the exhaust emission is not sufficiently heated, the condensed water can not be evaporated, but is splashed or spattered by the flow of the measurement gas. Then, the condensed water travels through the exhaust pipe with the exhaust emissions so as to enter into the gas sensor via the gas inlet hole of the outer cover of the gas sensor.

As described above, the position of the gas inlet hole of the outer cover is different from that of the inner cover along the center axis of the gas sensor. Thus, it is possible to prevent condensed water which is introduced through the gas inlet hole of the outer cover from flowing into the gas chamber formed inside the inner cover. However, if a large amount of condensed water traveling with the exhaust emissions is introduced into the clearance between the outer cover and the inner cover with high velocity, it is difficult to completely avoid the introduction of condensed water into the gas chamber. As a result, some of the large amount of condensed water can arrive in the gas chamber and adhesion of the condensed water to the gas sensing element may occur.

In order to accurately measure the concentration of the specific gas, it is necessary to keep the temperature of the gas sensor in an activation range thereof. Thus, if adhesion of the condensed water occurs, the gas sensing element and/or the heater may be damaged due to, for example, rapid cooling thermal shock.

Further, if the average velocity of the flow of the measurement gas in the direction of the center axis of the exhaust pipe is high, the measurement gas introduced into the clearance between the outer cover and the inner cover via the gas inlet hole of the outer cover maintains its velocity and leaves the clearance, going outside of the outer cover.

Further, the flow of the high velocity measurement gas tends to pass the gas sensor without entering the clearance through the gas inlet hole of the outer cover.

As described above, when the structure of the cover assembly is designed such that invasion of the condensed water, which is produced when the internal combustion engine is started, is prevented, the input amount of the measurement gas is simultaneously reduced. This leads to a declination in response characteristic of the gas sensor. In other word, the effect of protecting the sensor element from water splash is related to be contrary to improvement in the response characteristic of the gas sensor.

### SUMMARY OF THE INVENTION

The present invention has been made taking the above mentioned problems into consideration, an object of the present invention is to provide a device that allows to fixedly support a sensor.

A device for fixedly supporting a sensor so that the sensor is exposed to a gas to be measured flowing through a passage is provided. The sensor comprises a gas sensing element that detects a physical characteristic of the gas, and a cover that surrounds the sensing element and has a gas inlet hole through which the gas is introduced inside the gas cover. The supporting device is arranged to face the gas inlet hole outside the cover so as to have a gap left between the supporting device and the gas cover.

Using the device, a supporting structure of a sensor is provided, wherein in the supporting structure utilizing the device, it is possible to effectively avoid adhesion of condensed water to the sensing element and to obtain response speed characteristics from the gas sensor.

The sensor is exemplified by a gas sensor such as a nitrogen oxide sensor, an oxide sensor and the like. The supporting structure of the gas sensor is particularly useful in providing an installation structure of the gas sensor to a gas flowing passage, such as the exhaust pipe in the exhaust system of an internal combustion engine, in order to avoid damage to the gas sensor caused by water splash while improving the response speed characteristics from the gas sensor.

Other examples of the sensor are a temperature sensor, a pressure sensor or the like.

According to one aspect of the present invention, there is provided a supporting structure for a sensor, including a sensor that has a sensing element detecting at least one of the physical characteristics of a measurement gas. Also included is a gas cover surrounding the sensing element having a gas inlet hole through which the measurement gas is introduced to an inner space of the cover in which the measurement gas is detected by the gas sensing element. In this inner space, the sensor is supported in the flow of the measurement gas such that the measurement gas enters the inner space of the gas cover through the gas inlet hole. Also there is a screening member having a screening gate that screens the gas inlet hole of the cover assembly from the flow of the measurement gas, so as to provide an entrance space together with an exterior surface of the gas cover of the sensor in front of the gas inlet hole. The screening gate of the screening member has, for example, a boss cylindrical shape surrounding the gas inlet hole with a gap between the gas inlet holes and the screening gate.

The screening member serves as a adjustor that adjusts the exposed length of the sensor, the sensor having a longitudinal axis and tip end located inside a pipe in which the measurement gas flows, the exposed length of the sensor being defined as the length between a cross section of the sensor continued from an interior surface of the pipe to the tip end of the gas sensor along the longitudinal axis of the sensor.

According to another aspect of the present invention, there is provided a supporting structure of a gas sensor including a gas sensor that measures the concentration of a specific component contained in a measurement gas and the screening member for interrupting the flow of the measurement gas. The gas sensor has a sensing element, a housing, and a gas cover. The gas sensor's length is measured between a base side end and a tip side end opposite to the base side end along a longitudinal center line thereof. The sensing element has a function of detecting the specific gas component contained in the measurement gas. The gas sensing element is retained within the housing and has a given length extending in the longitudinal center line of the gas sensor. The housing has a base side end and a tip side end opposite to the base side end along the longitudinal center line of the gas sensor. The gas cover is installed in the tip side end of the housing and has a length extending in alignment with the longitudinal center line of the gas sensor. The gas cover is designed to surround the sensing element. It is preferable that the gas cover is made up of an outer cover and an inner cover. Both the outer cover and the inner cover have their respective base side ends and their respective tip side ends opposite to the corresponding base side ends along the longitudinal center line of the gas sensor and have a respective gas inlet hole through which the measurement gas is introduced to the inside space of the inner cover through the gas inlet hole of the outer cover. The gas inlet hole of the outer cover is such that the measurement gas is caught by the gas sensing element when the tip side end of the gas sensor is exposed to the part of the measurement gas. The screening member is arranged to be radially-opposite to the gas inlet hole of the outer cover in a circular polar coordinate defined on a cross sectional plane perpendicular to the longitudinal center line of the gas sensor so as to gate the gas inlet hole of the outer cover.

According to further another aspect of the present invention, there is provided a gas sensor including a gas sensor that measures the concentration of a specific component contained in a measurement gas and a screening member for interrupting the flow of the measurement gas.

The gas sensor has a sensing element, a housing, a gas cover, and a screening member. The gas sensor's length is measured between a base side end and a tip side end opposite to the base side end along a longitudinal center line thereof. The sensing element has the function of detecting the specific gas component contained in the measurement gas. The gas sensing element is retained within the housing and has a given length extending in the longitudinal center line of the gas sensor. The housing has a base side end and a tip side end opposite to the base side end along the longitudinal center line of the gas sensor. The gas cover is installed in the tip side end of the housing and has a length extending along alignment with the longitudinal center line of the gas sensor. The gas cover is designed to surround the sensing element. It is preferable that the gas cover is made up of an outer cover and an inner cover. Both the outer cover and the inner cover have their respective base side ends and their respective tip side ends opposite to the corresponding base side ends along the longitudinal center line of the gas sensor and have a respective gas inlet hole through which the measurement gas is introduced to an inside space of the inner cover via the gas inlet hole of the outer cover and the gas inlet hole of the inner cover such that the measurement gas is caught by the gas sensing element when the tip side end of the gas sensor is exposed to the part of a measurement gas. The screening member is arranged to be radially-opposite to the gas inlet hole of the outer cover in a circular polar coordinate defined on a cross sectional plane perpendicular to the longitudinal center line of the gas sensor so as to gate the gas inlet hole of the outer cover.

### BRIEF DESCRIPTION OF THE DRAWINGS

The present invention will be understood more fully from the detailed description to be given hereinbelow and from the accompanying drawings of the preferred embodiment of the invention, which is not taken to limit the invention to the specific embodiments but should be recognized for the purpose of explanation and understanding only.

In the drawings:

FIG. 1 is a longitudinal sectional view showing a supporting member of a gas sensor according to a first embodiment of the present invention, the gas sensor being equipped with a cover assembly including an outer cover and an inner cover in which respective gas inlet holes are formed, and the supporting structure according to the present invention comprising a screening member that screens the gas inlet hole of the outer cover from the flow of a measurement gas to be detected by the gas sensor;

FIG. 2 is an enlarged view showing the supporting structure of the gas sensor shown in FIG. 1, including the tip side half of the gas sensor;

FIG. 3 is a perspective view showing outer and inner covers of the gas cover assembly of the gas sensor;

FIG. 4 is a perspective view showing a screening member according to the first embodiment of the present invention;

FIG. 5 is an explanatory view illustrating the flow of the measurement gas in the vicinity of the gas cover assembly and the gas sensing element in a cross sectional plane of the supporting structure of the gas sensor according to the present invention along the V-V line shown in FIG. 1;

FIG. 6 is an explanatory view illustrating the flow of condensed water in the vicinity of the supporting structure of the gas sensor according to the present invention;

FIG. 7 is a side view showing a testing apparatus used to evaluate the effect of the supporting structure of the gas sensor shown in FIG. 1 on adhesion of water dropped with air from the upstream of a pipe;

FIG. 8 is a graph showing results of tests performed using the testing apparatus shown in FIG. 8 about an total area splashed by condensed water;

FIG. 9A is a graph showing the change in air fuel ratio of an incident mixture with time in the tests performed using the testing apparatus shown in FIG. 8;

FIG. 9B is a graph showing the change in output of the gas sensor with time in the tests performed using the testing apparatus shown in FIG. 7 when the incident mixture is analyzed using the gas sensor;

FIG. 10 is a graph showing the output gain of the gas sensor which is used in the tests shown in FIG. 7, and a conventional gas sensor;

FIG. 11 is a longitudinal sectional view showing a supporting member of a gas sensor according to a first modification of the first embodiment, the supporting member being constituted of a plurality of parts made of different materials;

FIG. 12 is a longitudinal sectional view showing a conventional installation structure of a gas sensor equipped with a cover assembly including an outer cover and an inner cover in which respective gas inlet holes are formed to a measurement gas passage;

FIG. 13 is an explanatory view illustrating the flow of the measurement gas in the vicinity of the gas cover assembly and the gas sensing element in a cross sectional plane of the conventional installation structure of the gas sensor along the XIII-XIII line shown in FIG. 12;

FIG. 14 is an explanatory view illustrating the flow of condensed water in the vicinity of the conventional installation structure of the gas sensor;

FIG. 15 is a longitudinal sectional view showing a second modification of the supporting member according to the first embodiment of the present invention, the supporting structure having a gas sensor including a gas sensing element formed in a cup shape;

FIG. 16 is a longitudinal sectional view showing a sensing element included in the supporting member shown in FIG. 15;

FIG. 17 is a longitudinal sectional view showing a supporting member of a gas sensor according to a second embodiment of the present invention, the gas sensor being equipped with a cover assembly including an outer cover and an inner cover in which respective gas inlet holes are formed, and the supporting structure according to the present invention comprising a screening member that screen the gas inlet hole of the outer cover from a flow of a measurement gas to be detected by the gas sensor;

FIG. 18 is a perspective view showing a screening member according to the second embodiment of the present invention; and

FIG. 19 is a perspective view showing a screening member according to a third embodiment of the present invention.

### DESCRIPTION OF THE PREFERRED EMBODIMENTS

Preferred embodiments of the present invention will be explained below with reference to attached drawings. Identical parts are denoted by the same reference numerals throughout the drawings.

In the following, the gas sensor is used as a sensor that is supported by using an embodiment of the present invention. However, other sensors such as a temperature sensor, a pressure sensor and the like, are possible.

### First Embodiment

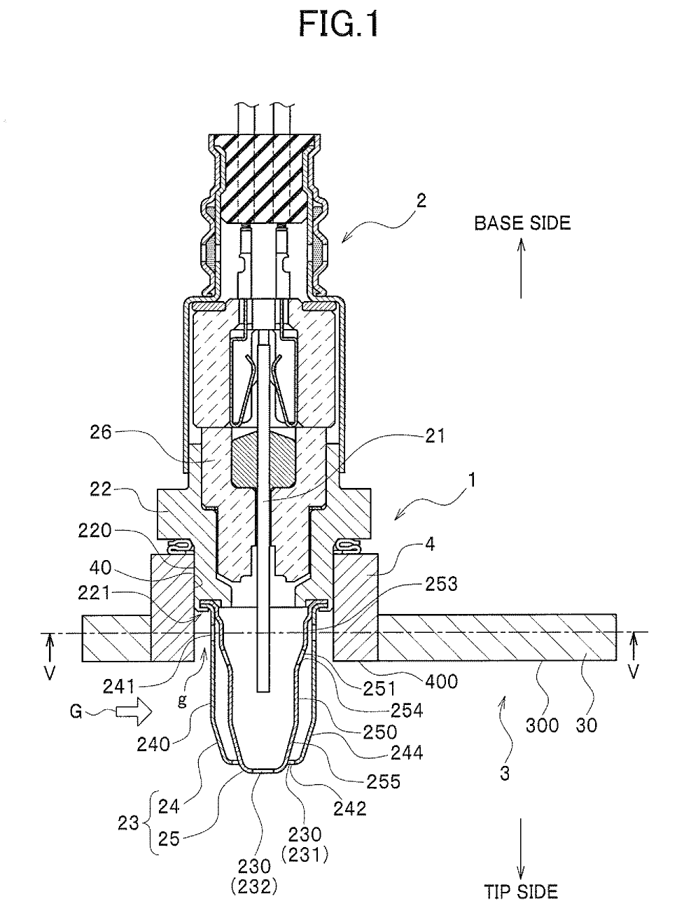

Referring to FIGS. 1-16, a first embodiment of the present invention will be described.

FIG. 1 is a longitudinal sectional view showing a supporting structure 1 of a gas sensor 2 equipped with a cover assembly 23 including an outer cover 24 and an inner cover 25 in which respective gas inlet holes 241, 251 are formed. The supporting structure 1 according to the present invention further comprises a screening member 4 that screens the gas inlet hole 241 of the outer cover 24 from the flow of a gas to be detected by the gas sensor 2 (hereinafter referred to as a “measurement gas”) G. The gas sensor 2 has a length along a longitudinal center line thereof and has a base side end and a tip side end opposite to the base side end along the longitudinal center line thereof.

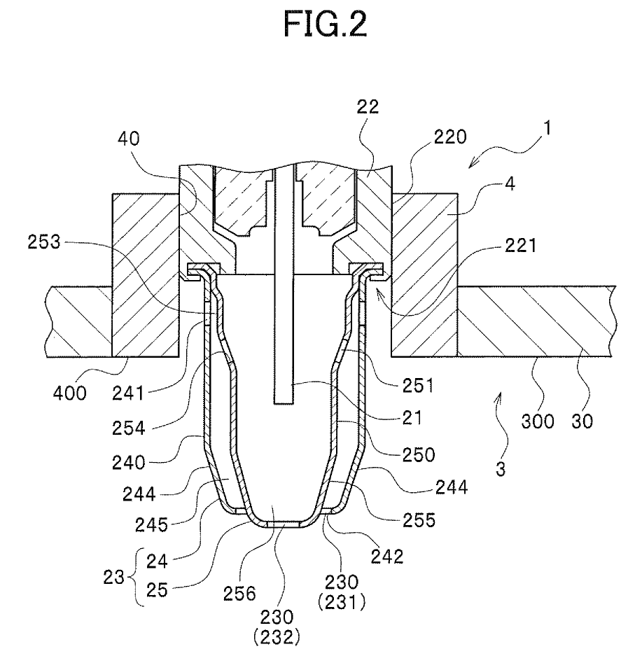

FIG. 2 is an enlarged view showing the supporting structure 1 of the gas sensor 2 shown in FIG. 1, including the tip side half of the gas sensor 2.

As shown in FIGS. 1 and 2, a supporting structure 1 of a gas sensor 2 according to the present invention is designed to fixedly support the gas sensor 2 so as to be exposed to the measurement gas G in a measurement gas flow path 3. The gas sensor 2 measures the concentration of a specific gas contained in the measurement gas flow G.

For example, the gas sensor 2 is an air-fuel ratio sensor and is installed in the exhaust pipe of the exhaust system of an automotive vehicle having an internal combustion engine. The exhaust system is widely used to control the air-fuel ratio of a mixture fed into the internal combustion engine in order to control combustion therein. In this case, the measurement gas is the exhaust emissions discharged from the internal combustion engine, thus the flow of the measurement gas is an exhaust gas flow. Further, an oxygen (O₂) sensor that measures the concentration of oxygen contained in the exhaust emission or a nitrogen oxide (NOx) sensor may be allowed as the gas sensor 2. The NOx sensor is attached on the downstream side of a NOx-absorbing catalyst to perform a process in which the air-fuel ratio of exhaust emission is changed from a lean one to a rich one, and the air-fuel ratio is returned again to the lean ratio at a stage at which NOx is completely removed by the catalyst, in order to reduce NOx occluded by the catalyst.

The gas sensor 2 comprises a gas sensor element 21, a housing 22, a gas cover assembly 23, and a porcelain member 26 as shown in FIGS. 1 and 2. The gas sensing element 21 has a function of detecting a specific gas component contained in the measurement gas. The housing 22 substantially has a hollow cylindrical shape and retains the gas sensing element 21 therein such that a part of the gas sensing element 21 extends from the housing 22 towards the tip side end of the gas sensor 2. The gas cover assembly 23 is designed to surround the part of the gas sensing element 21 extending from the housing 22 towards the tip side end of the gas sensor 2 so as to be exposed to the flow of the measurement gas.

The gas cover assembly 23 includes the outer cover 24 and the inner cover 25. The outer cover 24 partially warps the inner cover 25. That is, the tip side end of the inner cover 24 appears through a gas outlet hole 242. The inner outer cover 24 is formed in a cup shape.

In this embodiment, the cover assembly 23 has the inner cover 24 and the outer cover 25. However, it is possible that the cover assembly 23 has only outer cover 24.

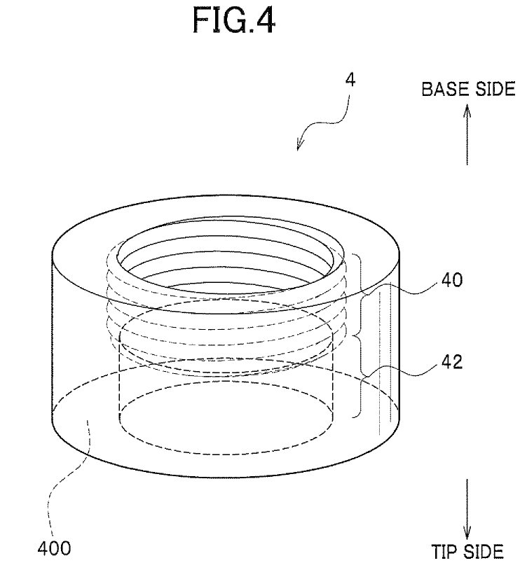

FIG. 4 is a perspective view showing a screening member 4. The screening member 4 has substantially boss cylindrical shape, as shown in FIG. 4. The screening member 4 serves as a boss and includes a thread portion 40 at which a female thread is cut and a gate portion 42 which faces the gas inlet hole 241 of the outer cover 24.

The screening member 4 has roughly a cylindrical shape with a bore therein and has a base side end and a tip side end opposite to the base side end along the longitudinal center line thereof. The tip side end 400 of the screening member 4 serves as a wall to the flow of the measurement gas flow path 3. Further, the screening member 4 is arranged to be radially-opposite to the gas inlet hole 241 of the outer cover 24 in a circular polar coordinate defined on a cross sectional plane traversing the longitudinal center line thereof so as to gate the gas inlet hole 241 of the outer cover 24.

The diameter of the inner circle of the cylindrical screening member 4 is larger than that of an outer surface of the outer cover 24. That is, there is a gap between the interior surface of the screening member and the outer surface of the outer cover such that the gas inlet hole 241 of the outer cover 24 is screened by the screening member 4. This gas occupies an entrance space in which slow or moderate flow of the measurement gas is caused.

It is preferable that the dimensions of the screening member is determined considering not only the dimension of the gas sensor 2, but also the flow velocity of the measurement gas, the diameter of the cross section of the measurement gas flow path 3.

In a special case, the longitudinal center line of the screening member 4 is identical to that of the gas sensor 2, and the screening member 4 is arranged to be radially-opposite to the gas inlet hole 241 of the outer cover 24 in a circular polar coordinate defined on a cross sectional plane perpendicular to the longitudinal center line of the gas sensor 2 so as to gate the gas inlet hole 241 of the outer cover 24.

The tip side end of the gas cover assembly 23 is located on the measurement gas flow path 3. If the measurement gas flow path 3 is enclosed by a wall, the gas cover assembly 23 is arranged to be projected from the wall to which the tip side end 400 of the screening member 4 participates.

The screening member 4 is made of a metal material such as stainless containing chrome. However, other material having a rigidity or stiffness comparable to that of metal such as a ceramic is allowable.

It is preferable that the screening member 4 is made of the same material of which the housing 22 is made. If the screening member 4 and the housing 22 are made of the same material, it is possible to reduce an occurrence of sticking at connecting surface between the screening member 4 and the housing 22.

Further, in the above description, the screening member is an external device to the gas sensor. However, the screening member could be one of the constituents of the gas sensor.

The housing 22 has a base side end and a tip side end opposite to the base side end along the longitudinal center line of the gas sensor. The gas cover assembly 23 is installed in the tip side end of the housing and has a length extending in alignment with the longitudinal center line of the gas sensor.

The porcelain member 26 is fitted within the housing 22 and holds the gas sensing element 21 therein.

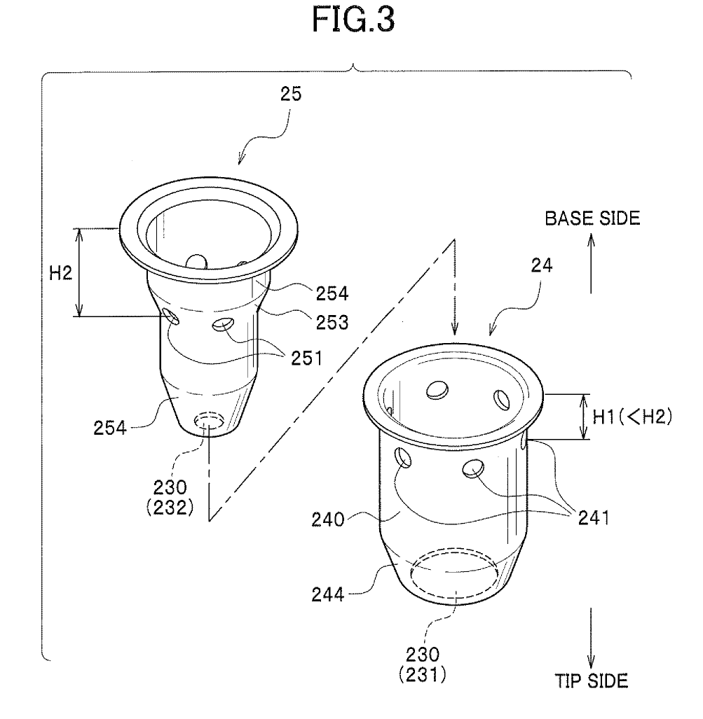

FIG. 3 is a perspective view showing the outer cover 24 of the gas sensor 2 and an inner cover 25. The inner cover 25 is inserted into the outer cover 24. The outer cover 24 has its length along the longitudinal center line of the gas sensor 2, thus, it has a tip side end and a base side end thereof. The outer cover 24 has a cylindrical portion 240 and a tapered portion 244. The base side end of the cylindrical portion 240 is attached to the housing 22. The tapered portion 244 is formed at the tip side end of the cylindrical portion 240 such that the diameter of a cross section of the tapered portion 244, the cross section having substantially a circular shape in a plane traversing the longitudinal center line of the gas sensor 2, is gradually reduced as the tip side end of the tapered portion 244 is approached.

A gas inlet hole 241 though which the measurement gas is introduced inside the outer cover 24 is formed in the cylindrical portion 240 of the outer cover 24.

A gas outlet hole 242 though which the measurement gas is discharged from the inside space of the outer cover 24, is disposed at the tip side end of the tapered portion 244.

The inner cover 25 has a length along the longitudinal center line of the gas sensor 2, thus, has a tip side end and a base side end thereof, as similar to the outer cover 24 shown in FIG. 4A. The inner cover 25 has a first cylindrical portion 253, a first tapered portion 254, a second cylindrical portion 250, and a second tapered portion 255, in this order from the base side end to the tip side end. The first cylindrical portion 253 and the first tapered portion 254 are connected such that their inner and outer peripheral surfaces smoothly continued. The second cylindrical portion 250 and the second tapered portion 255 and are connected in the same manner. The first and the second tapered portion are formed such that diameters of these are gradually reduced as the tip side end of the tapered portion 244 is approached.

The inner cover 25 has an gas inlet hole 251 in the first tapered portion 253 and an gas outlet hole 232 in the second tapered portion 255. The gas outlet hole 232 has substantially circular shape. The gas outlet hole 232 is opened towards the tip side end of the gas sensor 2 such that the center of the gas outlet hole 232 is on the longitudinal center line of the gas sensor 2.

The gas outlet hole 242 of the outer cover 24 and the gas outlet hole 232 of the inner cover 25 have a central role to decrease the rate-limiting diffusion process in the inside space of the gas cover assembly 23.

The maximum diameter of the outer cover 24 is larger than that of the inner cover 25, but the longitudinal length of the outer cover 24 is shorter than that of the inner cover 25. The gas outlet hole 242 of the outer cover 24 is substantially formed in a circular shape. The gas outlet hole 242 has a big enough diameter such that the tip side end of the second tapered portion 254 of the inner cover 25 protrudes from the gas outlet hole 242 of the outer cover 24. That is, the outer cover 24 can fully wrap the first cylindrical portion 254, the first tapered portion 253, and the second cylindrical portion 250, but cannot wrap the second tapered portion 255 of the inner cover 25, when the base side ends of both the outer cover 24 and the inner cover 25 are attached to the tip side end of the housing 22. In other words, the length of the outer gas cover 24 along the longitudinal center line of the gas sensor 2 is shorter than that of the inner cover 25.

If the flow of the measurement gas G is in an interior space of a pipe 30, an inner peripheral wall 300 forms a wall to the flow of the measurement gas flow path 3 together with the tip side end 400 of the screening member 4.

Returning to FIGS. 1 and 2, the gas cover assembly 23 has a gas outlet hole 230 at the tip side end thereof. The gas outlet hole 230 is constituted of a first gas outlet hole 231 and a second gas outlet hole 232. The first gas outlet hole 231 is formed between the periphery of the outlet hole 242 and the outer peripheral surface of the second tapered portion 255 of the inner cover 25. The second gas outlet hole 232 is formed at the tip side end of the inner cover 25.

The gas cover assembly 23 is fastened to the tip side end of the housing 22 by crimping. In more detail, at the base side end of the gas cover assembly 23, edges of the inner cover 24 and the outer cover 25 form layers. The housing 22 has a crimping portion 221 at the tip side end thereof. The layers are simultaneously crimped through the crimping portion 221 to be fastened to the housing 22 in an air-tight manner.

The tip side end of the gas cover assembly 23 projects from the tip side end of the screening member 4.

If a plurality of gas inlet holes 241 are formed in the cylindrical portion 240 of the outer cover 24, all the plurality of the gas inlet holes 241 have the same distance from the base side end of the outer cover 24, as shown in FIG. 3.

Similarly, if a plurality of gas inlet holes 251 are formed in the first tapered portion 254 of the inner cover 25, all the plurality of the gas inlet holes 251 have a same distance from the base side end of the inner cover 25, as shown in FIG. 3.

The inlet hole 241 of the outer cover 24 is closer to the base side end of the gas cover assembly 23 than the inlet hole 251 of the inner cover 25. In other words, the distance H1 between the inlet hole 241 of the outer cover 24 and the base side end of the gas cover assembly 23 is larger than a further distance H2 between the inlet hole 251 of the inner cover 25 and the base side end of the gas cover assembly 23, as shown in FIG. 3.

When the gas cover assembly 23 having the outer cover 24 and the inner cover 25 is fastened to the housing in the above mentioned manner, the position of the inlet hole 241 of the outer cover 24 along the longitudinal center line of the gas sensor 2 corresponds to that of the first cylindrical portion 253 of the inner cover 25.

In this embodiment, the tip side end of the inner cover 24 appears through the gas outlet hole 242. However, it is allowable that the tip side ends of the inner cover 24 and the outer cover 25 have an identical distance from the base side end of the gas cover assembly 23. Further it is allowable that the outer cover 24 can fully warp the first cylindrical portion 254, the first tapered portion 253, the second cylindrical portion 250, and the second tapered portion 255 of the inner cover 25. That is, the longitudinal length of the inner cover 25 is shorter than that of the outer cover 24.

As shown in FIG. 2, a clearance 245 between the outer cover 24 and the inner cover 25 is formed. Further, a space being inside the inner cover 25 at which the measurement gas is detected by the gas sensing element 21 is referred to as a gas chamber 256. The measurement gas is introduced from the flow of the measurement gas flow path 3 to the chamber 256 through the gas inlet hole 241 of the outer cover 24, the clearance 245, and the gas inlet hole 251 of the inner cover 25.

In general, gas sensing elements have a laminated structure. That is, the gas sensor elements have a solid electrolyte body made mainly of zirconia, a measurement gas electrode, a reference gas electrode, and a heater. The measurement gas electrode and the reference gas electrode are affixed to opposite surfaces of the solid electrolyte body. The measurement gas electrode is exposed to the measurement gas. The reference gas electrode is exposed to air when air is used as the reference gas.

The heater heats the solid electrolyte body of the gas sensing element up to 400 degrees Celsius or more to keep the temperature of the gas sensing element in its activation range when in use.

The gas sensing element 21 is designed to detect both the concentration of oxygen (O₂) and the concentration of nitrogen oxide (NOx). Thus, the gas sensing element 21 shown 3 has two cells, that is, a pump cell for sensing the concentration of oxygen (O₂) and a sensor cell for sensing the concentration of nitrogen oxide (NOx).

The gas sensing element 21 has a laminated structure including a pump cell, a porous diffusion layer, a sensor cell, an atmosphere duct and a heater. In the sensing element 21, a Cartesian coordinate can be defined with an upper surface and a lower surface opposite to the upper surface in a perpendicular axis, and a left side surface and a right side surface opposite to the left-side surface in a horizontal axis. The gas sensing element 21 is extended to a space inside the inner wall 25 so that the upper surface, the lower surface, and the left side surface thereof will be exposed to the measurement gas.

The pump cell extends between the porous diffusion layer and the gas chamber 245 in which the gas sensing element 21 is fixedly supported. The upper side surface of the pump cell has a first electrode, and the lower side surface of the pump cell has a second electrode. The sensor cell extends between the porous diffusion layer and the atmospheric duct. The upper side of the sensor cell has a third electrode, and the lower side surface of the sensor cell has a fourth electrode. The measurement gas flows from left the side surface of the gas sensing element 21 to the porous diffusion layer.

Each of the pump cell and the sensor cell has a solid electrolyte layer made of a ceramic. The ceramic contains ZrO₂, HfO₂, ThO₂, or Bi₂O₂ into which CaO, MgO, Y₂O₃, or Yb₂O₃ is introduced as a stabilizer by a solution treatment. The porous diffusion layer 501 is made of heat resisting inorganic material such as alumina, magnesia, quartzite, spinel, or mullite.

The first electrode of the pump cell, and the third and fourth electrodes of the sensor cell are made of a noble metal such as platinum which has a high catalytic activity. The second electrode of the pump cell is mode of a noble metal or noble metal alloy such as gold-platinum alloy which is inactive to nitrogen oxide (NOx).

The heater is embedded in an insulating layer. The atmospheric duct is defined between the insulating layer and the sensor cell. Atmospheric gas is introduced into the atmosphere duct from an external space. The atmosphere in the atmosphere duct is used as a reference gas for estimating the concentration of oxygen (O₂) contained in the measurement gas. The insulating layer is made of, for example, alumina. The heater is made of a platinum-alumina cermet or another cermet. It is noted that although, in general, a cermet has properties of both a ceramic, such as hardness, and those of a metal, such as the ability to undergo plastic deformation, it is brittle, that is, is easily damaged due to a rapid cooling thermal shock or rapid heating thermal shock which generate thermal stress. The heater generates heat when the heater is supplied with electric power from an external power supplying apparatus. The heater activates the sensing element 21 including the pump cell and the sensor cell.

The gas sensing element 21 operates as follows. The measurement gas enters the porous diffusion layer via the left side end surface thereof. If the measurement gas is the exhaust emissions of an internal combustion engine, the measurement gas contains oxygen (O₂), nitrogen oxide (NOx), carbone dioxide (CO₂), and water (H₂O). A specific gas component of the measurement gas is pumped out by a decomposition reaction when electric potential is applied between the first and the second electrodes. More specifically, oxygen (O₂) is discharged into the pump cell and is ejected to the gas chamber 256 via the first electrode while a pump cell current Ip is generated in the pump cell and is detected by the first and the second electrodes.

The pump cell removes only a portion of the oxygen component from the measurement gas in the porous diffusion layer. The measurement gas which contains a remaining portion of the oxygen component flows through the porous diffusion layer from a region near the pump cell to a further region near the sensor cell. When a voltage is applied to the sensor cell, nitrogen oxide (NOx) is decomposed to nitrogen (N₂) and oxide (O₂). Thus, the decomposition of nitrogen oxide (NOx) creates new oxygen (O₂). Then, oxygen (O₂) constituted by the remaining oxygen (O₂) and the new oxygen (O₂) is drawn into the sensor cell from the porous diffusion layer while a sensor cell current Is is generated in the sensor cell as an indication of the concentration of nitrogen oxide (NOx) contained in the measurement gas. The sensor cell current Is generated in the sensor cell is detected by the third and the fourth electrodes of the sensor cell.

The gas sensing element 21 is controlled by the control apparatus 600. The second electrode of the pump cell and the third electrode of the sensor cell are connected to ground in the control device. In the control device, an applied voltage command circuit outputs a voltage command signal Vh(com) to the non-inverting input terminal of an amplifier circuit. The output terminal of the amplifier circuit is connected to the first electrode of the pump cell via a resistor. The resistor detects the pump cell electric current Ip. The voltage Vh at the first electrode of the pump cell is fed back to an inverting input terminal of the amplifier circuit. Hence, the amplifier circuit equalizes the voltage Vh at the first electrode of the pump cell to the value of the voltage command signal Vh(com). Therefore, the voltage Vh at the first electrode of the pump cell is controlled by the voltage command signal Vh(com).

The pump cell electric current Ip which depends on the oxygen (O₂) concentration in the measurement gas is detected as a voltage across the resister.

The fourth electrode of the sensor cell is connected to a positive terminal of the power supply via a resistor. A negative terminal of the power supply is grounded. The resistor acts to detect the sensor cell electric current Is. The sensor cell electric current Is depends on the concentration of nitrogen oxide (NOx) contained in the measurement gas. Thus, the concentration of nitrogen oxide (NOx) is obtained via the voltage across the resistor.

In the above configuration of the control apparatus, it is assumed that the sign of the pump cell current Ip and the sensor cell current Is are unchanged. It is possible to design the control apparatus 600 so as to allow a negative pump cell current Ip and/or a negative sensor cell current Is.

The gas sensor 2 having the above described gas sensing element 21 is installed to, for example, the exhaust pipe 30 of the exhaust system of an automotive vehicle having an internal combustion engine. Inside the exhaust pipe 30, the measurement gas path 3 is formed. The screening member 4 is disposed in the exhaust pipe 30 such that the base side end of the screening member 4 projects from an exterior peripheral surface of the exhaust pipe 30.

The housing 22 has a tip side end portion 220 at which a male thread is cut to be screwed into the boss of the screening member 4. Thus, the gas sensor 2 is installed to the exhaust pipe 30 via the screening member 4.

As shown in FIGS. 1 and 2, the screening member 4 has the tip side end 400 which is a substantially flat surface on a plane traversing the longitudinal center line of the gas sensor 2. In a special case, the screening member 4 has the tip side end 400 which is a substantially flat surface on a plane perpendicular to the longitudinal center line of the gas sensor 2, as shown in FIGS. 1 and 2. The tip side end 400 of the screening member 4 constitutes a continuous surface with the interior peripheral surface 300 of the exhaust pipe 30.

The screening member 4 is arranged to be radially-opposite to the gas inlet hole 241 of the outer cover 24 in a circular polar coordinate defined on a cross sectional plane traversing the longitudinal center line of the gas sensor 2 so as to gate the gas inlet hole 241 of the outer cover 24. In FIGS. 1 and 2, the screening member 4 is arranged to be radially-opposite to the gas inlet hole 241 of the outer cover 24 in a circular polar coordinate defined on a cross sectional plane traversing the longitudinal center line of the gas sensor 2 so as to gate the gas inlet hole 241 of the outer cover 24. In a special case, the screening member 4 is arranged to be radially-opposite to the gas inlet hole 241 of the outer cover 24 in a circular polar coordinate defined on a cross sectional plane perpendicular to the longitudinal center line of the gas sensor 2 so as to gate the gas inlet hole 241 of the outer cover 24.

If the outer cover 24 has a plurality of the gas inlet holes 241, the screening member 4 gates all the plurality of the gas inlet hole 241 of the outer cover 24.

In this embodiment, if the height of the gas inlet hole 241 is measured by a distance along the longitudinal center line of the gas sensor 2 between the gas inlet hole 241 of the outer cover 24 and the base side end of the outer cover 24, that is, a distance along the longitudinal center line of the gas sensor 2 between the gas inlet hole 241 of the outer cover 24 and the tip side end of the housing 22, all the plurality of the gas inlet hole 241 of the outer cover 24 have the same height. However, it is possible to have a plurality of the gas inlet holes 241 having different heights thereof. In such the situation, the screening member 4 should be arranged to be radially-opposite to all the plurality of gas inlet holes 241 so as to gate all the plurality of gas inlet holes 241.

For example, the gas inlet hole 241 of the outer cover 24 has a diameter of 1.5 millimeter. The distance between the gas inlet hole 241 formed in the cylindrical portion 240 of the outer cover 24 and the surface of the screening member 4 can be adjusted from 1 to 10 millimeters.

In this embodiment, the screening device has substantially cylindrical shape. It is possible the thread portion 40 of the screening device and the gate portion 42 overlap each other. That is, the opposite surface to the gas inlet hole 241 of the outer cover has the female thread.

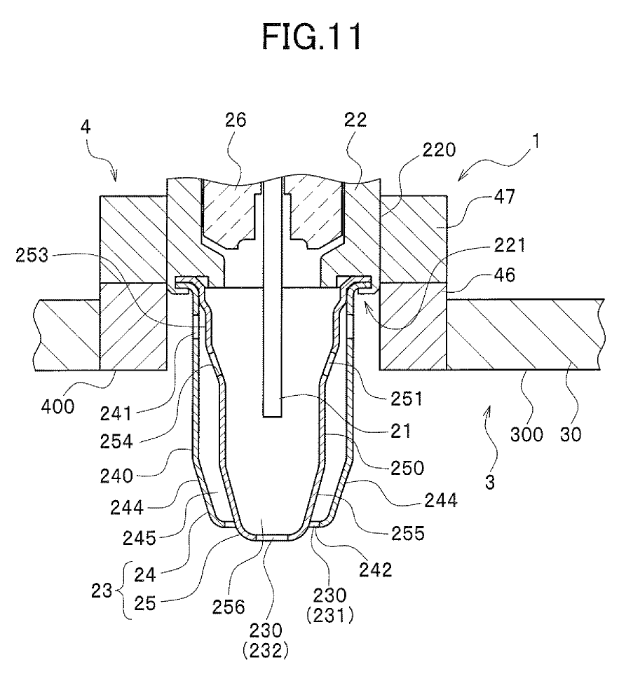

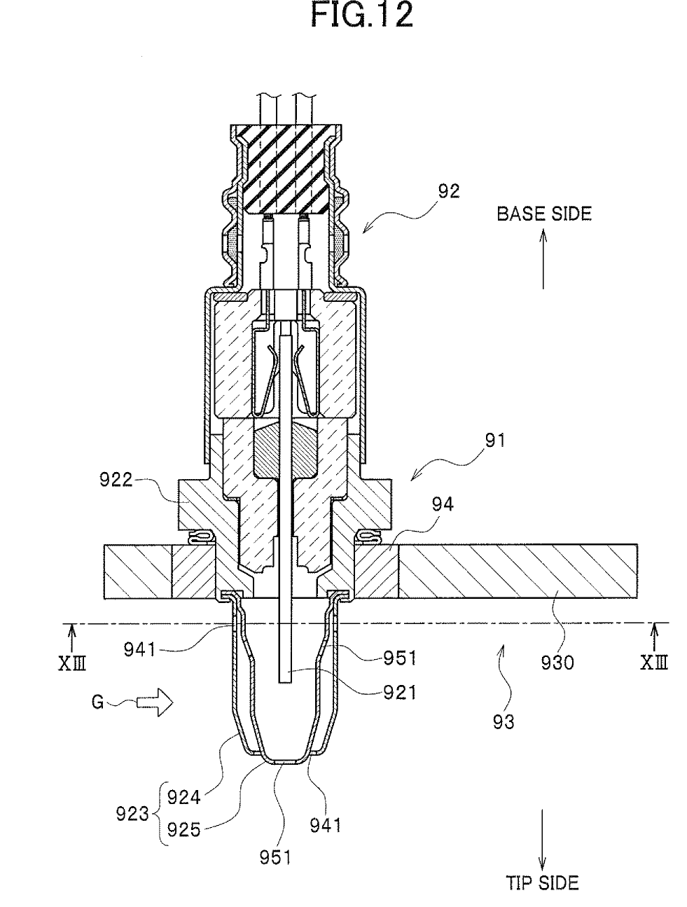

Further, it is preferable that the thread portion 47 and the gate portion 46 are made of different materials to each other, as shown in FIG. 11.

In this embodiment, the screening member serves as an adjustor that adjusts an exposed length of the gas sensor, the exposed length of the sensor being defined as the length between a cross section of the sensor continued from an interior surface of the pipe to the tip end of the gas sensor along the longitudinal axis of the gas sensor.

(The Effects of the Supporting Structure According to this Embodiment)

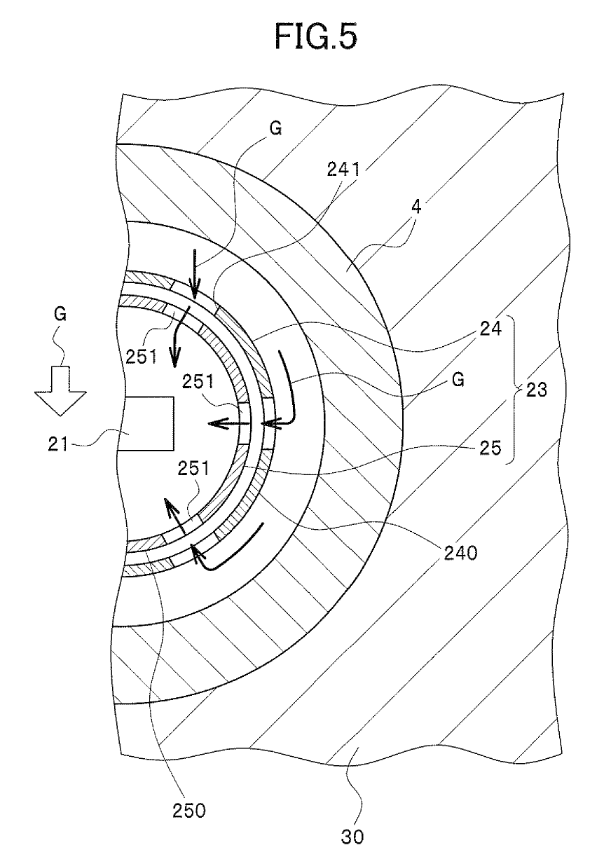

The supporting structure 1 of the gas sensor 2 according to this embodiment offers effects which will be described with referring to FIGS. 5-10 and 12-14.

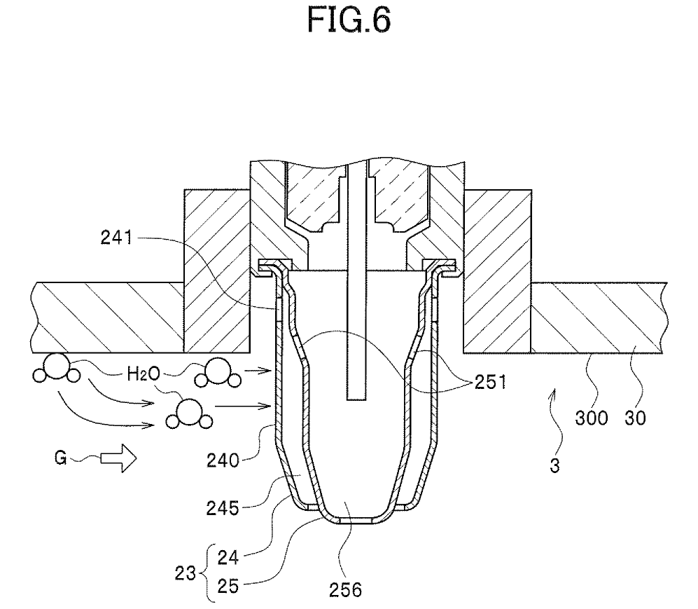

FIG. 6 is an explanatory view illustrating the flow of the measurement gas in the vicinity of the gas cover assembly 23 and the gas sensing element 21 in a cross sectional plane of the supporting structure 1 of the gas sensor 2 along the A-A line shown in FIG. 1;

Referring to FIG. 51 the flow of the measurement gas G will be discussed.

The flow of the measurement gas G in the measurement gas flow path 3 formed inside the pipe 30 strikes with the cylindrical portion 240 of the outer cover 24. The portion of the flow of the measurement gas which strikes with the tapered portion 244 can be neglected in discussing the flow of the measurement gas inside the outer cover 24. The measurement gas is slowed due to scattering with the outer cover 24 and is introduced into the entrance space between the screening member 4 and the outer cover 24 of the cover assembly 23. Then, the slowed measurement gas enters the clearance 245 between the outer cover 24 and the inner cover 25 through one inlet hole 241 of the outer cover 24. At this stage, the measurement gas does not have sufficient velocity to leave from the clearance 245 to the interior space of the pipe 30 via another inlet hole 241 of the outer cover 24. Therefore, a large portion of the measurement gas introduced into the clearance 245 between the outer cover 24 and the inner cover 25 will enters the gas chamber 256 through the inlet hole 251 of the outer cover 25 to be detected by the gas sensing element 21.

Since the tip side end of the cover assembly 23 is located near a center of the flow of the measurement gas flow path 3, measurement gas having a high velocity along the center of the flow of the measurement gas flow path 3 passes in the vicinity of the tip side end of the cover assembly 23. Thus, due to Bernoulli's theorem of fluid mechanics, negative pressure relative to that of the gas chamber 256 is generated in the vicinity of the tip side end of the cover assembly 23. As a result, the flow of the measurement gas G streams smoothly from the gas chamber 256 to the measurement gas flow path 3 through the gas outlet hole 230. Then, the pressure of the gas chamber 256 becomes lower then that of the clearance 245 between the outer cover 24 and the inner cover 25. This leads the flow of the measurement gas G into the gas chamber 256 formed inside the inner cover 25.

It may be useful to clarify the effects of the supporting structure 1 of the gas sensor 2 by comparing those of a conventional installation structure of a gas sensor.

FIG. 12 is a longitudinal sectional view showing a conventional installation structure 91 of a gas sensor 92 equipped with a cover assembly 923 including an outer cover 924 and an inner cover 925 in which respective gas inlet holes 941, 951 are formed to a measurement gas passage 930. The gas sensor 92 has a length defining a longitudinal center line thereof and has a base side end and a tip side end opposite to the base side end along the longitudinal center line thereof, as shown in FIG. 12. A measurement gas path 93 is formed inside the measurement gas passage 930.

The gas sensor 92 has basically the same structure with the gas sensor 2. Therefore, the gas sensor 92 has a gas sensing element 921 for detecting a specific gas component contained in the measurement gas. The housing 922 substantially has a hollow cylindrical shape and retains the gas sensing element 921 therein such that part of the gas sensing element 921 extends from the housing 922 towards the tip side end of the gas sensor 992. The gas cover assembly 923 is designed to surround the part of the gas sensing element 921 extending from the housing 922 towards the tip side end of the gas sensor 92 so as to be exposed to the flow of the measurement gas g.

The cover assembly 923 has the same structure as the cover assembly 23 shown in FIGS. 1 and 2. That is, the outer cover 924 and the inner cover 925 correspond to those shown in FIG. 3. The gas cover assembly 923 is fastened to the tip side end of the housing 922 by crimping

The conventional installation structure 91 further comprises a installation member 94 though which the gas sensor 92 is attached to the measurement gas passage 930.

The gas sensor 92 has a gas sensing element 921 and a housing 922. The gas sensing element 921 is retained in the housing 922. The gas sensor 92 has the similar structure to the gas sensor 2.

As shown in FIG. 12, the conventional installation structure 91 has a continuous surface composed of an interior peripheral surface of the measurement gas passage 930 and a tip side end surface of the installation member 94. However, the tip side end of the housing 922 of the gas sensor 92 also participates in the continuous surface composed of the interior peripheral surface of the measurement gas passage 930 and the tip side end surface of the installation member 94.

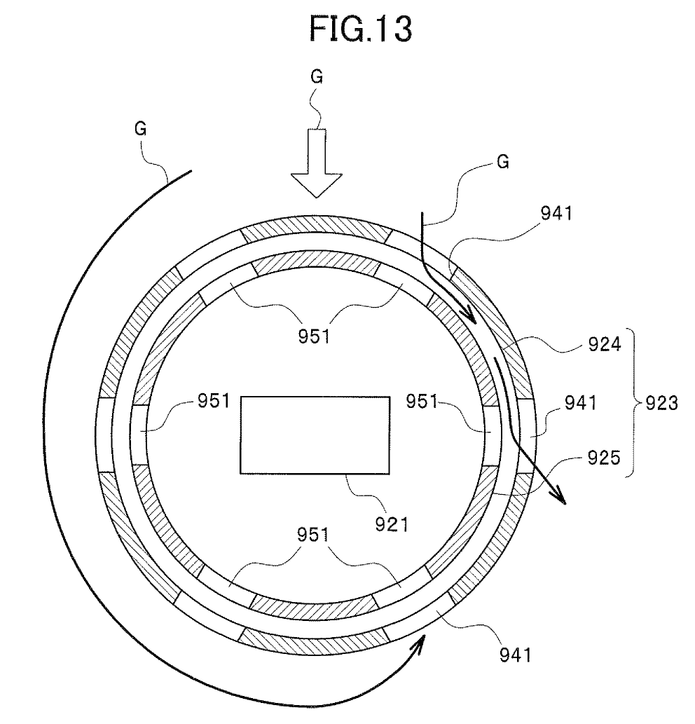

FIG. 13 is an explanatory view illustrating the flow of the measurement gas G in the vicinity of the gas cover assembly 923 and the gas sensing element 921 in a cross sectional plane of the conventional installation structure of the gas sensor along the XIII-XIII line shown in FIG. 12.

As shown in FIG. 13, the measurement gas once introduced into a clearance between the outer cover 924 and the inner cover 925 through the inlet hole 941 of the outer cover 924 will escapes from the clearance and return to the measurement gas path 93. Further, if an average velocity of the flow of the measurement gas is high, the measurement gas flows around the gas sensor. Thus, the measurement gas does not easily enter into the clearance between the outer cover 924 and the inner cover 925 through the inlet hole 941 of the outer cover 924.

FIG. 6 is an explanatory view illustrating a flow of condensed water in the vicinity of the gas cover assembly 23 when the internal combustion engine is started. For example, in a cold environment, condensed water can be present on the interior peripheral surface 300 of the exhaust pipe 30 of the exhaust system of the internal combustion engine due to condensation of water contained in the exhaust emissions of the internal combustion engine, and from the air. If the internal combustion engine is started in the presence of condensed water at the interior peripheral surface 300 of the exhaust pipe 30, especially when the exhaust emissions are not sufficiently heated, the condensed water can not be evaporated, but is splashed or spattered by the flow of the measurement gas.

In the situation shown in FIG. 6, the inlet hole 241 is not located on a position in the exhaust pipe 30 where the measurement gas can not directly flows into the inlet hole 241. Therefore, it is possible to prevent the condensed water from entering the clearance 245 between the outer cover 24 and the inner cover 25 through the inlet hole 241 of the outer cover 24, and to the gas chamber 256 via the inlet hole 251 of the inner cover 25.

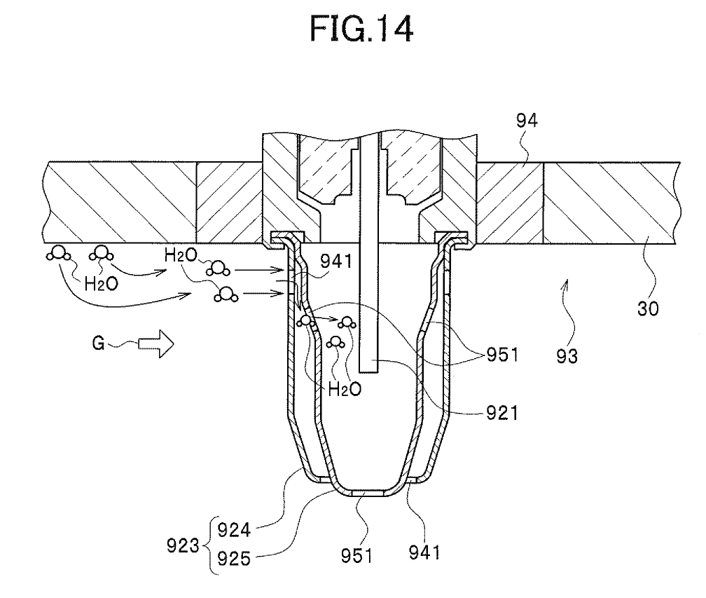

FIG. 14 is an explanatory view illustrating a flow of condensed water in the vicinity of the conventional installation structure 91 shown in FIG. 12. In this case, the condensed water can enter into the clearance 245 through the inlet hole 941 of the outer cover 924 and then into the gas chamber 256 through the inlet hole 951 of the inner cover 925.

In this embodiment, the supporting structure 1 of the gas sensor 2 has the gas sensor 2 which includes the outer cover 24 having the inlet hole 241 and the inner cover 24 having the inlet hole 251, and the screening member 4 which is arranged to be radially-opposite to the gas inlet hole 241 of the outer cover 24 in a circular polar coordinate defined on a cross sectional plane substantially perpendicular to the longitudinal center line of the gas sensor 2 so as to gate the gas inlet hole 241 of the outer cover 24.

Therefore, even if the velocity of the flow of the measurement gas G along the center line of the measurement gas flow path 3 is high, the measurement gas is not directly introduced into the clearance 245 through the inlet hole 241 of the outer cover 24 of the gas cover assembly 23. In other words, it is possible to prevent a high velocity component of the flow of the measurement gas G along the center line of the measurement gas flow path 3 from entering to the clearance 245 through the inlet hole 241 of the outer cover 24. Even if the high velocity component of the flow of the measurement gas G is accompanied by condensed water and the condensed water has a high velocity, the condensed water can not easily arrive at the gas chamber 256 through the clearance 245. Hence, the gas sensing element 21 is not damaged by condensed water in the gas chamber 256.

Therefore, it is possible to avoid any adhesion of condensed water or water splash and to prevent the sensing element from being damaged due to thermal shock, also improving the response speed characteristics of the gas sensor.

Further, as shown in FIG. 1, after the measurement gas G is scattered by the outer cover 24, a slow flow of the measurement gas g is generated in the entrance space between the screening member 4 and the outer cover 24. The slow flow of the measurement gas in the entrance space is directed to the base side end of the gas cover assembly 23 along the exterior surface of the outer cover 24. Then, the measurement gas constituting the slow flow of the measurement gas in the entrance space is introduced into the clearance 245 through the inlet hole 241 of the outer cover 24. Thus, it is possible to prevent the measurement gas from escaping from the entrance space between the screening member 4 and the outer cover 24 to the measurement gas flow path 3.

Further, because an incident measurement gas to the gas sensor 2 is sufficiently deaccelerated due to a collision with the outer cover 24 of the gas cover assembly 23, a circular flow of the measurement gas around the outer cover 24 in the plane substantially perpendicular to the longitudinal center line of the gas sensor 2 is not easily generated. Therefore, a sufficient amount of the measurement gas having moderate or low velocity can be introduced into the clearance 245 between the outer cover 24 and the inner cover 25, and then to the gas chamber 256 in which the measurement gas is detected by the sensing element 21 of the gas sensor 2.

Further, the screening member 4 is arranged to gate the gas inlet hole 241 of the outer cover 24, that is, to be radially-opposite to the gas inlet hole 241 of the outer cover 24 in the circular polar coordinate defined on a cross sectional plane substantially perpendicular to the longitudinal center line of the gas sensor 2 so as to gate the gas inlet hole 241 of the outer cover 24. This arrangement of the screening member 4 prevents from high velocity components from entering the flow of the measurement gas G to the clearance 245 and to a gas chamber 256.

If the outer cover 24 has a plurality of inlet holes 241, the screening member 4 is arranged to gate all the plurality of inlet holes 241. Hence it is possible to prevent measurement gas having high velocity from entering the clearance 245 and the gas chamber 256 through the inlet hole 241 of the outer cover 24 and the inlet hole 251 of the outer cover 25.

In this embodiment, the tip side end of the gas cover assembly 23 is located on the measurement gas flow path 3. In other words, the gas cover assembly 23 is arranged to be projected from the tip side end 400 of the screening member 4. Hence, it is possible to guide the measurement gas scattered by the gas cover assembly 23 to the clearance 245 formed between the screening member 4 and the outer cover 24. Therefore, the gas sensor 2 obtains the response speed characteristics.

As shown in FIGS. 1 and 2, the screening member 4 has a tip side end 400. The tip side end 400 of the screening member 4 has substantially flat surface in the plane substantially perpendicular to the longitudinal center line of the gas sensor 2. It is preferable that the tip side end 400 has a smooth surface. Thus, the measurement gas arriving around the cylindrical portion 240 of the outer cover 24 is smoothly introduced into the entrance space formed between the screening member 4 and the outer cover 24.

Further, the tip side end 400 participates in a continuous wall partially made of the interior peripheral surface 300 of the pipe 30. That is, there is not any blockage which the flow of the measurement gas G encounters while the measurement gas approaches the gas sensor 2. Hence, the measurement gas is smoothly introduced into the clearance 245 and then the gas chamber 256 through the entrance space between the screening member 4 and the outer cover 25.

As shown in FIG. 3, the inner cover 25 has the first cylindrical portion 253, the first tapered portion 254, the second cylindrical portion 250, and the second tapered portion 255, in this order from the base side end to the tip side end. The gas outlet hole 232 is formed in the second tapered portion 255. The gas outlet hole 232 has substantially circular shape. The gas outlet hole 232 is opened towards the tip side end of the gas sensor 2 such that the center of the gas outlet hole 232 is on the longitudinal center line of the gas sensor 2. Bernoulli's theorem of fluid mechanics states that negative pressure relative to that of the gas chamber 256 is generated in the vicinity of the tip side end of the cover assembly 23. As a result, the flow of the measurement gas G streams smoothly from the gas chamber 256 to the measurement gas flow path 3 through the gas outlet hole 232. Then, the pressure of the gas chamber 256 becomes lower than that of the clearance 245 between the outer cover 24 and the inner cover 25. This leads the flow of the measurement gas G from the clearance 245 into the gas chamber 256 formed inside the inner cover 25.

Therefore, a sufficient amount of the measurement gas is introduced into the clearance 245 between the outer cover 24 and the inner cover 25, and then to the gas chamber 256 in which the measurement gas is detected by the sensing element 21 of the gas sensor 2.

Consequently, the gas sensor 2 obtains the response speed characteristics of the gas sensor.

Therefore, in the supporting structure 1 of the gas sensor 2 according to the present invention, it is possible to prevent the gas sensor 2 from being damaged due to thermal shock caused by the adhesion of condensed water while improving the response speed characteristics of the gas sensor 2.

In this embodiment, the sensor, such as the gas sensor 2, constitutes a sensing means for at least one of the physical characteristics of the measurement gas. The supporting member 4 constitutes a supporting means for providing a gate by which an entrance space is provided together with the exterior surface of a cover for the sensor in front of the gas inlet hole 241 through which a measurement gas is introduced to a gas chamber and for adjusting an exposed length of the sensor. The exposed length of the sensor is defined by the length between a cross section of the sensor continued from an interior surface of the pipe to the tip end of the gas sensor along the longitudinal axis of the sensor.

(Demonstration of the Effects of the Supporting Member According to this Embodiment)

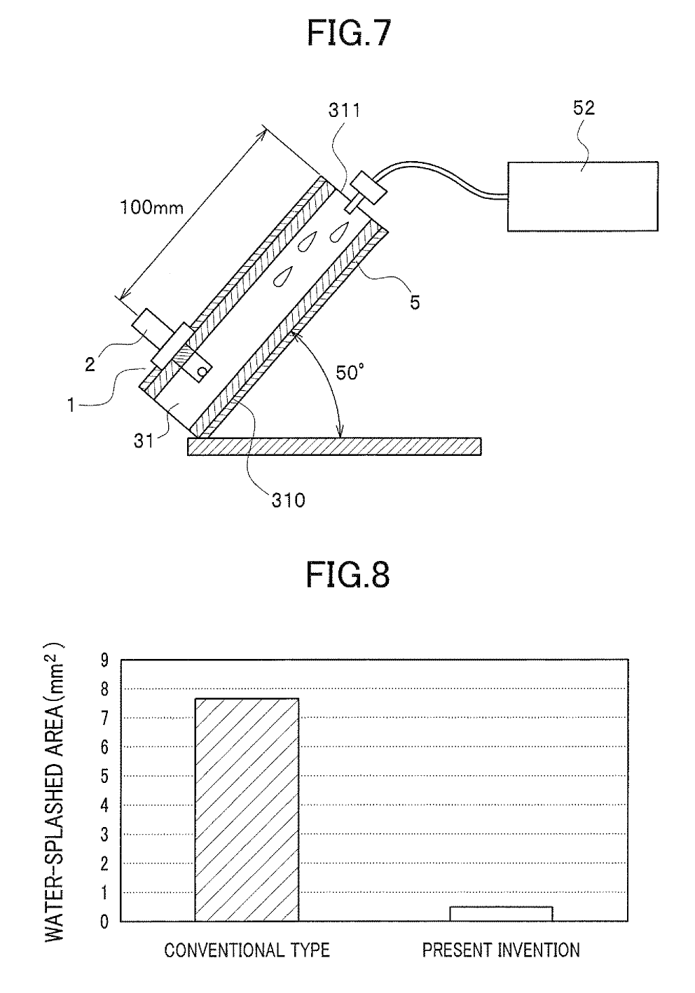

Referring to FIGS. 7-10, the effects of the supporting structure 1 of the gas sensor 2 will be demonstrated.

The supporting structure 1 of the gas sensor 2 shown in FIGS. 1 and 2 and the installation structure 91 of the gas sensor 92 shown in FIG. 12 are prepared in order to perform tests to evaluate the effects of the supporting structure 1 of the gas sensor 2 according to this embodiment.

First tests are performed to evaluate the effect of keeping the gas sensors 2 and 92 free from the adhesion of the condensed water.

FIG. 7 is a side view showing a testing apparatus used to evaluate the effect of the supporting structure 1 of the gas sensor 2 shown in FIG. 1 and the installation structure 91 of the gas sensor 92 shown in FIG. 12 on adhesion of water dropped with air from an upstream in a pipe 31.

The gas sensor 2 is installed in the pipe 31 using the supporting structure 1 according to the present embodiment.

The pipe 31 has an inner diameter of 35 millimeter and is inclined at 50 degrees to a horizontal plane. The pipe 31 has two open ends. The testing apparatus has an injector 52 that supplies water to the pipe 31. One of the open ends of the pipe 31 that connects to the injector 52 will be referred to as the upper open end 311. The interior space of the pipe 31 is heated by a heater 5 which is provided to the pipe 31 to maintain the temperature thereof.

The distance between the gas sensor 2 and the upper open end 311 of the pipe 31 is 100 millimeters.

The tests performed using the testing apparatus shown in FIG. 8 includes a step of injecting air containing condensed water from the upper open end 311 of the pipe 31. The air is supplied from the injector 52. This step is performed five times. The total surface area of the gas cover assembly 23 of the gas sensor 2 which suffered by the adhesion of the condensed water is tested.

The condensed water content of each jet of the air is 0.2 milliliters. The pressure of the jet of air is 0.15 kg/cm².

FIG. 8 is a graph showing results of tests performed using the testing apparatus shown in FIG. 7.

The graph shown in FIG. 8 tells that the area splashed with condensed water of the gas sensor 2 supported with the supporting structure 1 as shown in FIG. 1 is about 0.5 mm², while the area splashed with condensed water of the gas sensor 92 installed with the installation structure 91 as shown in FIG. 12 is about 7.7 mm². The gas sensor 2 and the gas sensor 92 have the same characteristics in sensing a specific gas contained in a measurement gas. According to FIG. 8, the area splashed with condensed water of the gas sensor 2 is less than one-tenth of that of the gas sensor 92. This is attributed to differences between the supporting structure 1 and the installation structure 91.

Therefore, it is possible that the supporting structure 1 according to the present embodiment can greatly reduce adhesion of condensed water to the gas sensing element 21 or to prevent the gas sensing element from being splashed with condensed water.

A second set of tests were performed to evaluate the response characteristics of the gas sensors 2 and 92.

The gas sensor 2 and the gas sensor 92 are installed in the exhaust pipe of an inline six-cylinder internal combustion engine. This engine is controlled to run at 2000 rpm.

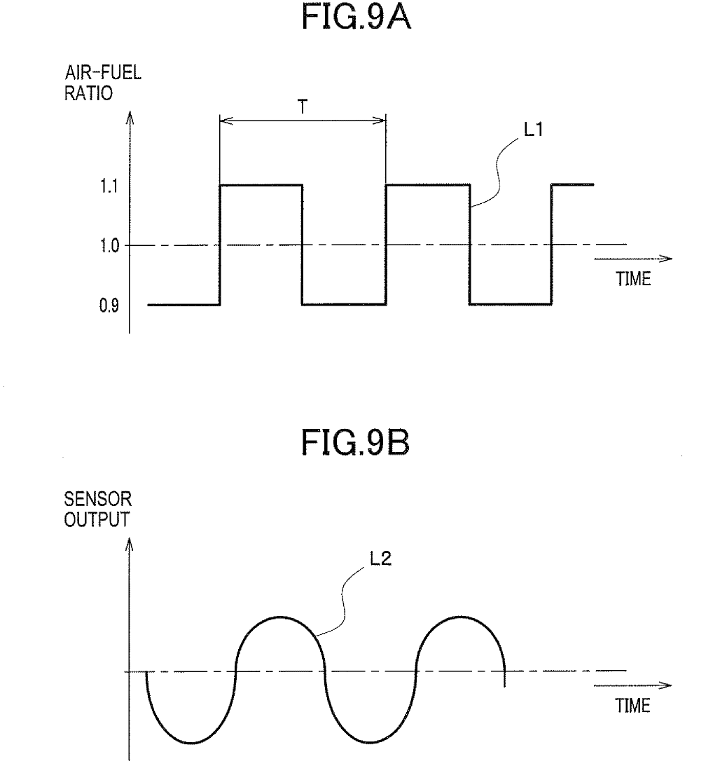

The second tests includes a step in which the air-fuel ratio of an incident mixture to the combustion engine is controlled such that the excess air ratio alternatively changes between 0.9 and 1.1 with time at a cycle of 4.16 Hz having period T, as represented as a line L1 shown in FIG. 9A.

In FIG. 9B, a line L2 shows the change in an output of the gas sensor 2 with time in the tests performed using the testing apparatus shown in FIG. 7 when the incident mixture is inputted to the gas sensor 2.

A sudden change in the air-fuel ratio of the incident mixture results in a change in the output of the gas sensor 2, as represented by a line L2. The gain of the gas sensor 2 is obtained by analyzing the line L2.

The same steps are performed on the installation structure 91 of the gas sensor 92. The gas sensor 92 has the same characteristics in sensing a specific gas contained in a measurement gas.

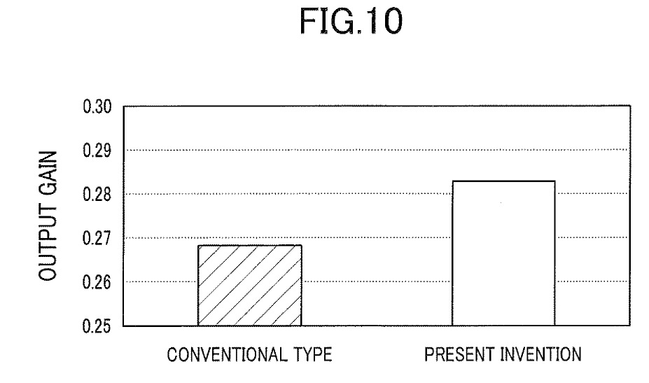

The graph in FIG. 10 tells that the supporting structure 1 of the gas sensor 2 has higher gain than the installation structure 91 of the gas sensor 92. That is, the supporting structure 1 of the gas sensor 2 is more responsive compared with that of the installation structure 91 of the gas sensor 92.

Consequently, the gas sensor obtains the improved response speed characteristics in sensing the specific gas contained in the measurement gas

The graphs shown in FIGS. 8 and 10 show that the supporting structure 1 of the gas sensor 2 according to the present embodiment can avoid being damaged due to thermal shock caused by the adhesion of condensed water while improving the response speed characteristics of the gas sensor.

(Advantages of the Supporting Member According to this Embodiment)

In the followings, advantages of the supporting structure 1 according to this embodiment will be explained.

In this embodiment, the screening member is constituted of a screening member for screening a directly entering flow of the measurement gas to the inlet hole 241 of the gas cover assembly 23.

According to one aspect of the present embodiment, there is provided a supporting structure of a sensor in the vicinity of the measurement gas flow path in which the sensor is exposed to a measurement gas so as to effectively avoid an adhesion of condensed water to the sensor and to obtain high responsiveness from the sensor, wherein the sensor is arranged to be exposed to the flow of a measurement gas.

In more detail, there is provided a supporting structure of a sensor including a sensor that has a sensing element detecting at least one of physical, mechanical, and electrical characteristics of a measurement gas, and a cover assembly surrounding the sensing element and having a gas inlet hole through which the measurement gas is introduced to the inner space of the cover assembly in which the measurement gas is detected by the gas sensing element, wherein the sensor is supported in the flow of the measurement gas such that the measurement gas enters the inner space of the gas cover assembly through the gas inlet hole, and the screening member has a screening gate that screens the gas inlet hole of the cover assembly from the flow of the measurement gas so as to gate the gas inlet hole. The screening member has, for example, a cylindrical shape with which the gas inlet hole is enclosed.

The sensor is exemplified by a gas sensor such as a nitrogen oxide sensor, an oxide sensor and the like. The supporting structure of the gas sensor is particularly useful to provide an installation structure of the gas sensor to a gas flowing passage, such as the exhaust pipe of the exhaust system of an internal combustion engine, in order to avoid damage to the gas sensor caused by water splash while improving the response speed characteristics of the gas sensor.

Accordingly, in the supporting structure of the gas sensor, the screening member is arranged to gate the gas inlet hole of the outer cover, that is, to be radially-opposite to the gas inlet hole of the outer cover in the circular polar coordinate defined on the cross sectional plane substantially perpendicular to the longitudinal center line of the gas sensor. In this arrangement, the screening member gates the gas inlet hole of the outer cover in order to prevent high velocity component of the measurement gas from entering a clearance formed between the outer cover and the inner cover and then to the gas chamber which is formed inside the inner cover, and the measurement gas is detected by the gas sensing element therein. In other words, the measurement gas, especially the high velocity component of the flow of the measurement gas cannot directly enter into the gas inlet hole of the outer cover. Thus, even if the measurement gas carries condensed water at high velocity, it is possible to prevent the high velocity component of the condensed water from entering the clearance formed between the outer cover and the inner cover and then into the gas chamber formed inside the inner cover. Therefore, it is possible to avoid any adhesion of condensed water to the sensing element and to prevent the sensing element from being damaged due to thermal shock while improving the response speed characteristics of the gas sensor.

Further, after the measurement gas incident to the gas sensor is scattered by the outer cover, the measurement gas with moderate or low velocity travels into the entrance space between the screening member and the outer cover toward the base side end of the outer cover. Then, the measurement gas is introduced to the clearance through the gas inlet hole of the outer cover. Thus, even if the outer cover has a plurality of gas inlet holes with different rotation angles in the cross sectional plane substantially perpendicular to the longitudinal center line of the gas sensor, the measurement gas once entered the entrance space via one of the plurality of the gas inlet holes does not leave from there through the other gas inlet hole. Further, it is possible to reduce the circular flow of the measurement gas around the cover assembly after an incident measurement gas to the gas sensor is scattered by the outer cover. Therefore, a sufficient amount of the measurement gas having moderate or low velocity can be introduced into the clearance between the outer cover and the inner cover, and then to the gas chamber in which the measurement gas is detected by the sensing element of the gas sensor.

Consequently, the gas sensor obtains the response speed characteristics in sensing the specific gas contained in the measurement gas.

According to the second aspect of this embodiment, there is provided an installation structure of the gas sensor comprising the gas sensor, a screening member, and the exhaust pipe of the internal combustion engine of the automotive vehicle. The gas sensor measures the concentration of the specific component contained in the exhaust emissions of the internal combustion engine of an automotive vehicle. The gas sensor is affixed in the exhaust pipe via the screening member.

Therefore, in the supporting structure of the gas sensor according to the present invention, it is possible to prevent the gas sensor from being damaged due to thermal shock caused by the adhesion of condensed water while improving the response speed characteristics of the gas sensor.

According to the this embodiment, the supporting structure 1 of the gas sensor 2 is in the vicinity of the gas flowing path 3 in which the gas sensor 2 is exposed to the measurement gas so as to effectively avoid an adhesion of condensed water to the gas sensor 2 and to obtain response speed characteristics of the gas sensor 2, wherein the gas sensor 2 is arranged to be exposed to the flow of the measurement gas in order to measure a concentration of a specific component contained in the measurement gas.

Regarding the gas sensor 2, an air-fuel sensor installed in an exhaust emission feed-back system of the internal combustion engine of an automotive vehicle, an oxygen (O₂) sensor that detects the concentration of oxygen (O₂) contained in the exhaust emissions and a nitrogen oxide (NOx) sensor that is installed in the exhaust pipe downstream of a catalytic converter in order to determine whether or not the catalytic converter has significantly deteriorated are allowed. The gas sensor 2 has a gas sensing element 21. The gas sensing element 21 has the laminated structure exemplified by that shown in FIG. 3.

The gas sensor element has a solid electrolyte body made mainly of zirconia, the measurement gas electrode, the reference gas electrode, and the heater. The measurement gas electrode and the reference gas electrode are affixed to opposite surfaces of the solid electrolyte body. The measurement gas electrode is exposed to the measurement gas. The reference gas electrode is to be exposed to air when air is used as the reference gas.

The heater works to heat the solid electrolyte body of the gas sensing element up to 400 degrees Celsius or more and to keep the temperature of the gas sensing element in its activation range when in use.

In the above discussion, the gas sensing element is retained by the housing 22. However, it is allowed that the porcelain member 26 of the gas sensor 2 in FIG. 1 retains the gas sensing element 21 instead of the housing 22 directly retaining the gas sensing element 21 therein. The porcelain member 26 is fitted within the housing 22.

In the supporting structure 1 of the gas sensor 2 according to the preferred embodiment, the screening member is arranged to gate the gas inlet hole 241 of the outer cover 24, that is, to be radially-opposite to the gas inlet hole 241 of the outer cover 24 in the circular polar coordinate defined on the cross sectional plane substantially perpendicular to the longitudinal center line of the gas sensor 2.

If the outer cover 24 has a plurality of gas inlet holes 241, the screening member gates all the plurality of the gas inlet holes 241 of the outer cover 24.

Therefore, even if the flow of the measurement gas includes a high velocity component therein, it is possible to prevent the high velocity component of the measurement gas from entering the gas inlet hole 241 of the outer cover 24.

In this embodiment, the gas cover assembly 23 is arranged to be projected from the tip side end 400 of the screening member. Hence, it is possible to easily guide the measurement gas scattered by the gas cover assembly 23 to the clearance 245 formed between the screening member 4 and the outer cover 24. Therefore, the gas sensor 2 obtains response speed characteristics.

Further, the tip side end 400 of the screening member 4 has substantially flat surface. Thus, the measurement gas arrived around the cylindrical portion 240 of the outer cover 24 is smoothly introduced into the entrance space formed between the screening member 4 and the outer cover 24. Hence, the measurement gas is smoothly introduced into the clearance 245, and then to the gas chamber 256 through the entrance space between the screening member 4 and the outer cover 25.

It is preferable that the tip side end 400 of the screening member 4 has a substantially flat surface in the plane substantially perpendicular to the longitudinal center line of the gas sensor 2.

Further, the tip side end 400 participates in a continuous wall partially made of the interior peripheral surface 300 of the pipe 30. That is, there is not any blockage through which the flow of the measurement gas G encounters while approaching the gas sensor 2. Hence, the measurement gas is smoothly introduced into the clearance 245 and then the gas chamber 256 through the entrance space between the screening member 4 and the outer cover 25.

In this embodiment, the gas outlet hole 232 is opened towards the tip side end of the gas sensor 2 such that the center of the gas outlet hole 232 is on the longitudinal center line of the gas sensor 2. Bernoulli's theorem of fluid mechanics states that negative pressure relative to that of the gas chamber 256 is generated in the vicinity of the tip side end of the cover assembly 23. As a result, the measurement gas G flows smoothly from gas chamber 256 to the measurement gas flow path 3 through the gas outlet hole 232. Then, the pressure of the gas chamber 256 becomes lower then that of the clearance 245 between the outer cover 24 and the inner cover 25. This leads the measurement gas G flows from the clearance 245 into the gas chamber 256 formed inside the inner cover 25.

Therefore, a sufficient amount of the measurement gas is introduced into the clearance 245 between the outer cover 24 and the inner cover 25, and then to the gas chamber 256 in which the measurement gas is detected by the sensing element 21 of the gas sensor 2.

Consequently, the responsiveness of the gas sensor 2 is greatly improved. Therefore, it is possible to avoid adhesion of condensed water or water splash and to prevent the sensing element from being damaged due to thermal shock while improving the response speed characteristics of the gas sensor.

In this embodiment, the gas outlet hole 232 is opened towards the tip side end of the gas sensor 2 such that the center of the gas outlet hole 232 is on the longitudinal center line of the gas sensor 2. Bernoulli's theorem of fluid mechanics states that negative pressure relative to that of the gas chamber 256 is generated in the vicinity of the tip side end of the cover assembly 23. As a result, the measurement gas G flows smoothly from gas chamber 256 to the measurement gas flow path 3 through the gas outlet hole 232. Then, the pressure of the gas chamber 256 becomes lower then that of the clearance 245 between the outer cover 24 and the inner cover 25. This leads the measurement gas G flows from the clearance 245 into the gas chamber 256 formed inside the inner cover 25.

Therefore, a sufficient amount of the measurement gas is introduced into the clearance 245 between the outer cover 24 and the inner cover 25, and then to the gas chamber 256 in which the measurement gas is detected by the sensing element 21 of the gas sensor 2.

Consequently, the gas sensor 2 obtains enhanced responsiveness. Therefore, it is possible to avoid any adhesion of condensed water or water splash and to prevent the sensing element from being damaged due to thermal shock while improving the response speed characteristics of the gas sensor.

In the above description, the screening member is an external device to the gas sensor. However, it is possible to design the screening member as one of the constituents of the gas sensor.

In more detail, there is provided a sensor including a sensor that has a sensing element detecting at least one of physical, mechanical, and electrical characteristics of a measurement gas, a cover surrounding the sensing element and having a gas inlet hole through which the measurement gas is introduced to an inner space of the cover in which the measurement gas is detected by the gas sensing element, wherein the sensor is supported in the flow of the measurement gas such that the measurement gas enters the inner space of the gas cover through the gas inlet hole, with a screening member having a screening gate that screens the gas inlet hole of the cover assembly from the flow of the measurement gas so as to gate the gas inlet hole. The screening member has, for example, a cylindrical shape with which the gas inlet hole is enclosed.

The sensor is exemplified by a gas sensor such as a nitrogen oxide sensor, an oxide sensor and the like. The supporting structure of the gas sensor is particularly useful to provide an installation structure of the gas sensor in a gas flowing passage, such as the exhaust pipe of the exhaust system of an internal combustion engine, in order to avoid damage to the gas sensor caused by water splash while improving the response speed characteristics of the gas sensor.

The screening member serves as a adjustor that adjusts the exposed length of the sensor so as to avoid any adhesion of condensed water or water splash and to prevent the sensing element from being damaged due to thermal shock while improving the responsiveness of the gas sensor, the exposed length of the sensor being defined as the length between a cross section of the sensor continued from an interior surface of the pipe to the tip end of the gas sensor along the longitudinal axis of the sensor.

(Modification)

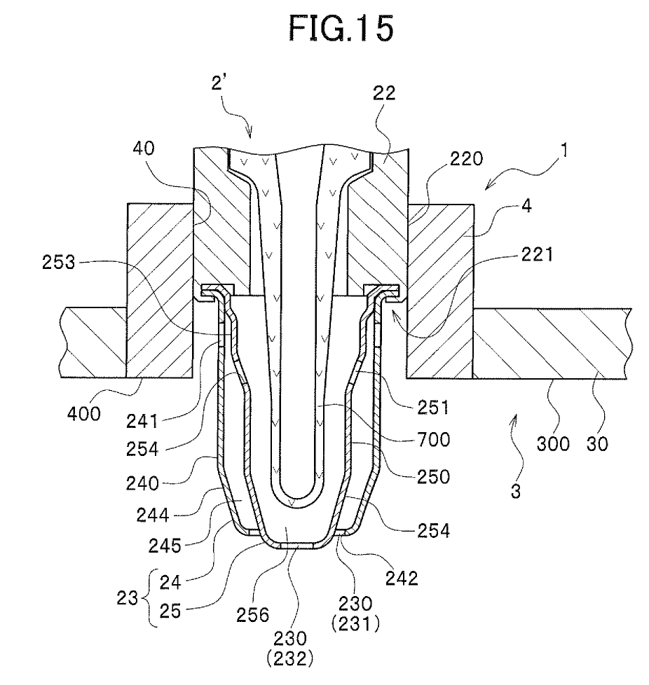

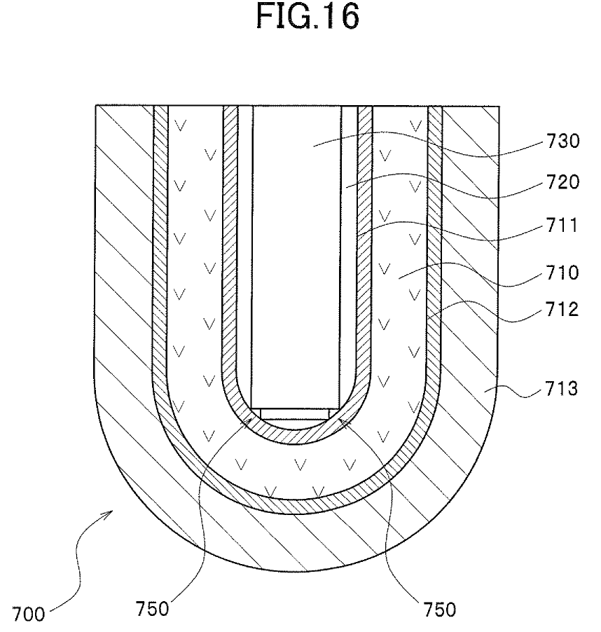

Referring FIGS. 15 and 16, a modification of the supporting structure 1 of the gas sensor 2 will be explained.

FIG. 15 shows the modification of the supporting structure 1′ of the gas sensor 2′ of the present invention which is similar to the supporting structure 1 of the gas sensor 2 except for the structure of gas sensing element. A gas sensing element 700 replaces the sensing element 21 having the laminated structure shown in FIG. 3. The gas sensing element 700 has a cup-shaped solid electrolytic element, as shown in FIG. 16.

As shown in FIG. 16, the gas sensor 2′ used in the supporting structure 1′ according to the modification of the supporting structure 1 of the gas sensor 2, comprises a gas sensing element 700 instead of the gas sensing element 2 in the supporting structure 1. The gas sensing element 700 includes a cup-shaped electrolytic element 710 having a reference gas chamber 720 defined therein. The cup-shaped electrolytic element 710 has substantially a cylindrical-shape. A measurement gas sensing electrode 712 is provided on an outer surface of the cup-shaped electrolytic element 710. A reference gas sensing electrode 711 is provided on the inner surface of the cup-shaped electrolytic element 710. The reference gas sensing electrode 711 faces the reference gas chamber 720. A heater 730 is accommodated in the reference gas chamber 720.

A contact portion 705 is provided on an outer cylindrical surface of the heater 730. The contact portion 750 is brought into contact with an inside surface of the reference gas chamber 720. In this arrangement of the heater 730, an amount of heat generated by the heater 730 is maximized in the vicinity of the contact portion 750. Therefore, even if the adhesion of condensed water to the gas sensing element 700 occurs, damage to the gas sensing element 700 due to thermal shock can be minimized.

The gas sensor 2′ is designed to prevent from causing thermal shock, for example, generation of cracks.

Therefore, it is possible to avoid damage to the gas sensor 2′ caused by water splash while improving the response speed characteristics of the gas sensor by using the screening member. That is, functions and effects identical with those of the preferred embodiment of the supporting structure 1 can be obtained in the supporting structure 1′ according to this modification of the preferred embodiment.

In the above description, the screening member is an external device to the gas sensor. However, it is possible to design the screening member as one of the constituents of the gas sensor.

In more detail, there is provided a sensor including a sensor that has a sensing element detecting at least one of physical, mechanical, and electrical characteristics of a measurement gas, a cover surrounding the sensing element and having a gas inlet hole through which the measurement gas is introduced to an inner space of the cover in which the measurement gas is detected by the gas sensing element, wherein the sensor is supported in the flow of the measurement gas such that the measurement gas enters the inner space of the gas cover through the gas inlet hole, and a screening member having a screening gate that screens the gas inlet hole of the cover assembly from the flow of the measurement gas so as to gate the gas inlet hole. The screening member has, for example, a cylindrical shape with which the gas inlet hole is enclosed.

The sensor is exemplified by a gas sensor such as a nitrogen oxide sensor, an oxide sensor and the like. The supporting structure of the gas sensor is particularly useful in providing an installation structure for the gas sensor in a gas flowing passage, such as the exhaust pipe of the exhaust system of an internal combustion engine, in order to avoid damage to the gas sensor caused by water splash while improving the response speed characteristics of the gas sensor.

### Second Embodiment

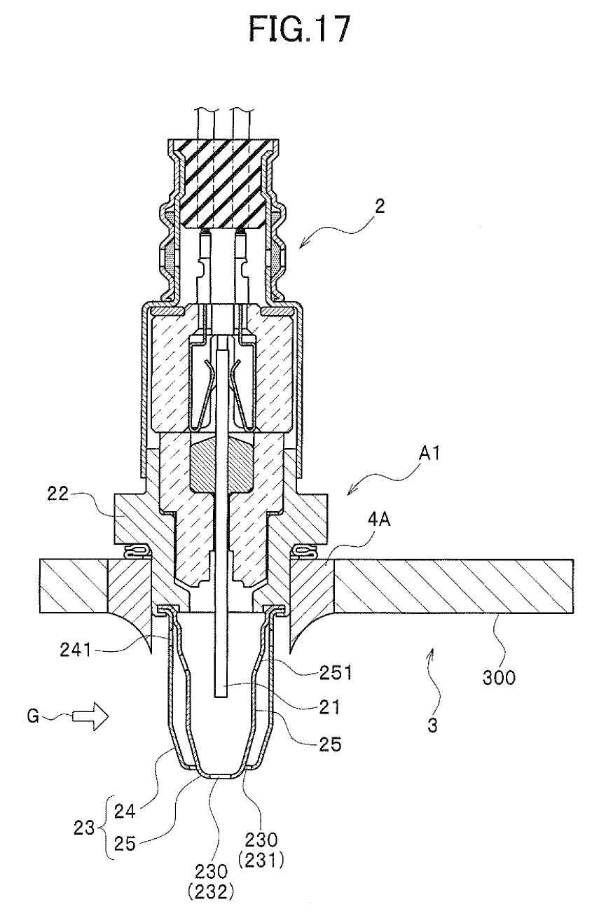

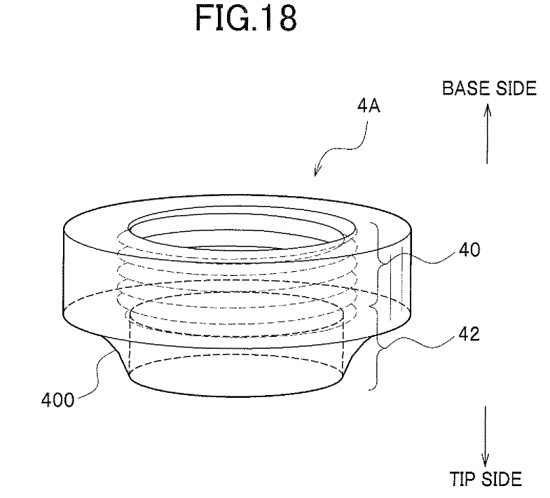

Referring to FIGS. 17-18, a screening member 4A according to a second embodiment of the present invention will be described.

FIG. 17 is a longitudinal sectional view showing the supporting member 4A of a gas sensor 2 according to the second embodiment of the present invention. Similar to the screening member 4 according to the first embodiment described above, the gas sensor 2 is equipped with a cover assembly 23 including the outer cover 24 and the inner cover 25 in which respective gas inlet holes 241, 251 are formed. The screening member screens the gas inlet hole 241 of the outer cover 24 from the flow of the measurement gas to be detected by the gas sensor 2.

FIG. 18 is a perspective view showing a screening member 4A according to the second embodiment of the present invention.

The screening member 4A has a cylindrical portion and a tapered portion in this order from a base side end to a tip side end thereof, as shown in FIG. 18. The tip side end of the screening member 4A is projected from a extended surface of the interior peripheral wall 300 of the pipe 30.

In this embodiment, the screening member 4A has a tapered portion at the tip side end of a cylindrical portion thereof. The tapered portion is arranged such that the thickness of the tapered portion between the outer surface and the inner surface becomes smaller on approaching the tip side end of the screening member.

A male thread is cut on the interior peripheral surface of the cylindrical portion and/or the interior peripheral surface of the tapered portion in order to adjust an exposed length of the gas sensor, the exposed length of the sensor being defined as the length between the cross section of the sensor continued from the interior surface of the pipe to the tip end of the gas sensor along the longitudinal axis of the sensor.

Further, it is possible to obtain the same functions and advantages of the screening member 4 as according to the first embodiment described above.

### Third Embodiment

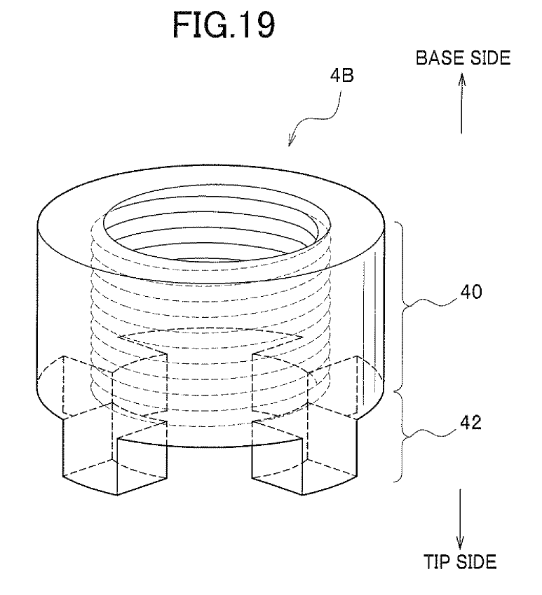

Referring to FIG. 19, a screening member 4B according to a second embodiment of the present invention will be described.

FIG. 19 is a perspective view showing a screening member according to a third embodiment of the present invention.

In this embodiment, the gate portion 42 which faces the gas inlet hole 241 of the outer cover 24 is not fully enclosed to the outer cover. The gate portion 42 is only formed in front of the gas inlet hole 241.

A male thread is cut on the interior peripheral surface of the cylindrical portion in order to adjust the exposed length of the gas sensor, the exposed length of the sensor being defined as the length between the cross section of the sensor continued from the interior surface of the pipe to the tip end of the gas sensor along the longitudinal axis of the sensor.

Further, it is possible to obtain the same functions and advantages of the screening member 4 as according to the first embodiment described above.

What is claimed is:

1. A device for fixedly supporting a sensor so that the sensor is exposed to a gas to be measured flowing through a passage, wherein
the sensor comprising:
a gas sensing element that detects a physical characteristic of the gas; and
a cover that surrounds the sensing element, and has a gas inlet hole through which the gas is introduced inside the gas covers and
the supporting device is arranged to face the gas inlet hole outside the cover so as to have a gap left between the supporting device and the gas cover.

2. The device according to claim 1, wherein
the supporting device is installed to a hole formed through the wall of a pipe providing the passage,
the sensor has a longitudinal axis and a tip side end being located inside the pipe along the longitudinal axis thereof, and further comprises a housing joined to the supporting device so that the sensing element is connected to the pipe via the housing and the supporting device,
the tip side end of the sensor is located inside the pipe,
the sensor has a first cross section that interpolates an inner surface of the wall of the pipe over the hole, and a second cross section that traverses the gas inlet hole and is parallel with the first cross section of the sensor, and
the first cross section and the tip side end of the gas sensor along the longitudinal axis of the sensor are located to provide a first distance therebetween that the gas inlet hole of the cover faces the device in the second cross section of the sensor.

3. The device according to claim 2, wherein
the gas inlet hole and the tip side end of the sensor along the longitudinal axis of the sensor are located to provide a second distance therebetween that the second distance is larger than the first distance, so that the second cross section traversing the gas inlet hole is beyond the inner surface of the wall of the pipe from the longitudinal center axis of the pipe.

4. The device according to claim 3, wherein
the supporting device has a substantially cylindrical shape with a bore therein, and has a longitudinal axis with two end surfaces at a tip side end and an opposite end to the tip side end, respectively, the tip side end surfaces being located at the near side end to the tip side end of the sensor and forming a smooth cross sectional end surface, and
the tip side end surface of the device and the inner surface of the wall of the pipe form a continuous surface.

5. The device according to claim 4, wherein
the sensor is a gas sensor that detects a concentration of a specified component contained in the measurement gas.

6. An installation structure of a gas sensor to a wall of a passage inside which a gas to be measured is occupied, comprising:
the gas sensor that detects a concentration of a specified component contained in the gas and has a longitudinal center line and a tip side end thereof, the tip side end of the gas sensor being placed inside the passage, and includes a sensing element, a housing retaining the sensing element therein, and a cover joined to the housing, wherein
the sensing element senses a physical characteristic of the gas,
the housing retains the sensing element therein, and
the cover surrounds the sensing element and has a gas inlet hole through which the gas is introduced to an inside space of the cover via the gas inlet hole of the cover, and
a screening member that is joined to the housing of the gas sensor and is arranged to face the gas inlet hole of the cover outside the cover so as to gate the gas inlet hole of the cover such that an entrance space is provided between the screening member and the cover of the sensor.

7. The installation structure according to claim 6, wherein
the cover is made up of an outer cover and an inner cover surrounding the sensing element and is covered by the outer cover, the outer cover and the inner cover having respective gas inlet holes through which the gas is introduced to the inside space of the inner cover.

8. The installation structure according to claim 7, wherein
the outer cover has a plurality of gas inlet holes, and
the screening member is arranged to be face all the plurality of the gas inlet holes of the outer cover in a circular polar coordinate defined on a cross sectional plane traversing the gas inlet hole of the outer cover.

9. The installation structure according to claim 8, wherein
the screening member has a longitudinal axis and a tip side end along a longitudinal axis thereof near the tip side end of the gas sensor, and
the gas cover is arranged such that the tip side end of the gas sensor is located deeper than that of the screening member inside the passage inside which the gas is occupied.

10. The installation structure according to claim 9, wherein
the tip side end of the screening member is on a plane crossing the longitudinal center line.

11. The installation structure according to claim 10, wherein
the screening member has a substantially boss cylindrical shape having a longitudinal axis and a tip side end along the longitudinal axis at which the screening member is terminated, the tip side end of the screening member being inserted to the a wall of the passage and forming a smooth cross sectional end surface of the substantially boss cylindrical device, and
the outlet hole of the cover is surrounded by the screening member with the entrance space formed between the device and an outer surface of the cover such that the gas inlet hole of the cover is gated for interrupting a flow of the gas

12. The installation structure according to claim 11, wherein
the sensor has a first distance that is defined as a distance between the first cross section thereof that interpolates the inner surface of the wall of the passage and the tip side end thereof along the longitudinal axis of the sensor, and a second distance is defined as a distance between the gas inlet hole formed in the gas cover thereof and the tip side end along the longitudinal axis of the sensor, a first cross section that interpolates an inner surface of the wall of the pipe over the hole, and a second cross section that traverses the gas inlet hole and is parallel with the first cross section of the sensor,
the screening member has a longitudinal axis with an end surfaces at a tip side end thereof the tip side end surfaces of the screening member is provided near the tip side end of the sensor and forming a smooth cross sectional end surface of the substantially cylindrical device with a bore therein,
the tip side end surface of the screening member and the inner surface of the wall of the passage form a continuous surface so as to prevent the gas from being scattered by the outer circumferential surface of the boss cylindrical device, such that the first distance is shorter than the second distance so that the second cross section traversing the gas inlet hole is beyond the inner surface of the wall of the pipe from the longitudinal center axis of the passage.

13. A sensor that measures a physical characteristic of a gas to be measured and has a longitudinal center line thereof and a tip side end along the longitudinal center line thereof, comprising:
a sensing element that senses the physical characteristic of the gas;
a housing that retains the gas sensing element therein such that the sensing element is exposed to the gas;
a cover joined to the housing and surrounding the sensing element and having a gas inlet hole through which the gas is introduced to an inner space of the cover where the gas is detected by the sensing element; and
a screening member that is jointed to the housing and is arranged to face the gas inlet hole of the gas cover outside the cover with a gap left between the screening member and the cover so as to gate the gas inlet hole of the cover for interrupting a flow of the gas.

14. The sensor according to claim 13, wherein
the sensor is a gas sensor, and
the gas sensing element that detects a concentration of a specific component contained in the gas.

15. The sensor according to claim 14, wherein
the gas sensor element is installed to a wall of a pipe thorough which the gas flows via the housing and the screening member,
the screening member has a longitudinal axis with two end surfaces at a tip side end and an opposite end to the tip side end, respectively, the tip side end surfaces being provided at the near side end to the tip side end of the sensor and forming a smooth cross sectional end surface, and
the tip side end surface of the screening member and the inner surface of the wall of the pipe form a continuous surface so as to prevent the gas from being scattered by the outer surface of the screening member.

16. The sensor according to claim 15, wherein
the screening member is arranged to be face all the plurality of the gas inlet holes of the outer cover on a cross sectional plane traversing the gas inlet hole of the cover.

17. The sensor according to claim 16, wherein
the cover has a plurality of the gas inlet holes through which the gas is introduced to the inner space of the cover, and
the screening member is arranged to gate all the plurality of the gas inlet holes of the cover.

18. The sensor according to claim 17, wherein
the screening member is arranged to have a first distance between the end surface of the screening member provided at an end near the tip side end of the sensor and the tip side end of the gas sensor along the longitudinal center line of the sensor,
the gas cover is arranged to have a second distance between the cross section of the sensor that traverses the gas inlet hole and the tip side end of the gas sensor along the longitudinal center line of the sensor, and
the first distance is smaller than the second distance so that the cross section of the sensor that traverses the gas inlet hole is outside the inner surface of the wall of the pipe.
